(19) United States
(12) Patent Application Publication
(10) Pub. No.: US 2011/0097157 A1
(43) Pub. Date: Apr. 28, 2011

(54) Deep Water Pipe Preparation Machine

(75) Inventors: Jeffrey Swiatowy, Crystal Lake, IL (US); Jacob Williams, Chicago, IL (US); Alexander Giberman, Northbrook, IL (US)

(73) Assignee: ILLINOIS TOOL WORKS INC., Glenview, IL (US)

(21) Appl. No.: 12/885,717

(22) Filed: Sep. 20, 2010

Related U.S. Application Data
(60) Provisional application No. 61/254,804, filed on Oct. 26, 2009.

(51) Int. Cl. F16L 1/00

(52) U.S. Cl. 405/184.1

(57) ABSTRACT

A device for preparing an underwater pipe includes a platform having moveable jaws for transporting the platform along a length of pipe. Mounted on the platform is a rotatable frame with a plurality of machines thereon, each of which can perform at least one function towards the preparation of the pipe.

The applicants claim priority from their provisional application filed Oct. 26, 2009 and assigned Ser. No. 61/254,804. The present application relates to the repair of underwater piping, and in particular to a device for cutting out a defective portion of pipe and preparing the two ends of the remaining pipe to receive a length of repair pipe.

### BACKGROUND OF THE INVENTION

Oil, gas, and other non-solids are transported along the ocean floor in pipes having steels walls that are formed by wrapping a steel plate into a hollow cylinder with the abutting ends of the plate welded together. The surfaces of the pipe are coated with a fusion bonded epoxy that prevents electrolysis from effecting the substance being transported in the pipe. When a section of the pipe becomes damaged as a result of movement of tectonic plates or a dragging anchor, a section of the defective pipe must be removed and a splice, in the form of a length of pipe with connectors at each end, inserted to replace the removed portion.

The repair process includes several steps, all of which must be undertaken at great depths, perhaps 10,000 feet, where there is total darkness, such that all work must be performed by robotics. To undertake the repair, a portion of the pipe is first lifted off the floor of the ocean and supported on a frame in order that robotics may reach around the entire circumference in the vicinity of the damage. Thereafter, the pipe must be cut in two locations to remove the damaged section. Before a replacement segment can be inserted, the ends of the pipe that extend in each direction away from the removed portion must be prepared to receive connectors suitable to seal.

The preparation of the ends requires that a bevel be formed on the outer circumference of the pipe wall, an inner bevel be provided on the inner circumference of the pipe, and that an annular portion of fusion bonded epoxy coating be removed from each of the two ends. Also, several inches of the weld seam that extends longitudinally along the exterior of the pipe must be removed to ensure a good seal between the connector and the outer surface of the remaining pipe sections. The five steps needed to prepare a length of pipe to receive a repair portion are therefore: 1) cut the pipe at two locations to remove the defective length, 2) bevel the inner circumference of the ends, 3) bevel the outer circumference of the ends, 4) remove a portion of the fusion bonded epoxy coating, and 5) remove a portion of the weld seam.

Presently, machines are available for undertaking each of the five steps. To undertake the steps, each machine must be lowered on cables from a control platform on the surface. The lowering, positioning, operating, and then raising of each of the machines in sequence consumes a great amount of time and greatly adds to the expense of such repairs. It would be desirable, therefore, to provide a single machine that can undertake all the steps necessary to prepare a damaged length of pipe for receiving the connectors of a repair section.

### SUMMARY OF THE INVENTION

Briefly, the present invention is a pipe preparation device for preparing a damaged portion of submerged pipe of the type having a protective outer coating on the surface thereof, and having a longitudinal weld seam along the outer surface thereof. The device includes a platform having a first clamp on said platform, the first clamp for selectively clamping and releasing around a circumference of the pipe, and a second clamp on the platform for selectively clamping and releasing around the circumference of the pipe where the second clamp is moveable toward and away from the first clamp. A motor is provided for moving the first clamp with respect to the second clamp so as to permit the device to move longitudinally along the length of pipe.

The device also includes a frame moveably attached to the platform where the frame is moveable in an arc around the circumference of the pipe. The frame has a cavity therein for retaining a flexible cable carrier wherein the flexible carrier retains electrical cable and hydraulic hoses. Mounted on the frame are one or more tools, where each of the tools is suitable for machining a surface of the pipe.

In accordance with one aspect of the invention, one or more guides are provided in the cavity for channeling the cable carrier as it unwinds as the frame rotates in one direction and rechanneling the flexible cable carrier back into the cavity as the frame rotates in the opposite direction. The guides permit the cable carrier to be sufficiently long to allow the frame to rotate through an arc from one end of its rotation to the opposite end thereof, which is greater than three hundred and sixty degrees. Without guides, a cable carrier having such length will lockup upon itself and fail. Without the guides, such cable carriers will generally not be useable for members rotating through three hundred and sixty degrees or more.

Where a plurality of tools are mounted on the frame and it is desirable that each of the tools operate against the entire three hundred and sixty degrees circumference of the length of pipe, the frame should be rotatable through more than three hundred and sixty degrees of arc without causing damage to any cables that connect the machine to the rotating elements.

Mounted on the frame are a plurality of machines for undertaking all five steps required to prepare a length of pipe to receive a repair section.

### BRIEF DESCRIPTION OF THE DRAWINGS

A better understanding of the invention will be had after a reading of the following detailed description taken in conjunction with the drawings wherein:

FIG. 1 is a of a length of pipe extending across the ocean floor having a damaged portion therein in need of repair;

FIG. 2 is a side elevational view of a machine in accordance with the present invention for repairing the pipe shown in FIG. 1;

FIG. 2A is an isometric view of the machine shown in FIG. 7;

FIG. 3 is a front view of the machine shown in FIG. 2;

FIG. 4 is an exploded view of the machine shown in FIG. 2, with the buoyancy material removed therefrom;

FIG. 4A is another exploded view showing the parts of the rotating frame and the cable carrier;

FIG. 5 is an isometric view of the forward “C” ring and a rear plate which form the center of the frame for the machine shown in FIG. 2;

FIG. 6 is a side view of the “C” ring and back plate shown in FIG. 5;

FIG. 6A is a greatly enlarged, cross-sectional view of the “C” ring as shown in FIGS. 5 and 6;

FIG. 7 is a front elevational view of the rear plate shown in FIGS. 5 and 6;

FIG. 8 is an isometric view of the front clamp assembly for the machine shown in FIG. 2;

FIG. 9 is a rear elevational view of the front clamp assembly shown in FIG. 8;

FIG. 10 is an exploded view of the front clamp assembly shown in FIG. 8;

FIG. 11 is a view of the front clamp assembly shown in FIG. 8 with the front plate removed and the parts assembled against the support plate;

FIG. 11A is a fragmentary enlargement of FIG. 11 showing details of the rod lock release that is assembled to the front plate;

FIG. 12 is a front elevational view of the front plate as shown in FIG. 8;

FIG. 13 is an exploded view of a clamp arm of the front clamp assembly shown in FIG. 8;

FIG. 14 is a isometric view of the rear clamp assembly for the machine shown in FIG. 2;

FIG. 15 is a front view of the rear clamp assembly shown in FIG. 14;

FIG. 16 is an isometric view of the rear clamp assembly shown in FIG. 14;

FIG. 17 is an assembly side view of the frame of the machine shown in FIG. 2;

FIG. 18 is a top view of the frame as shown in FIG. 17:

FIG. 19 is a front elevational view of the drive assembly for rotating the rotatable frame of the machine shown in FIG. 2;

FIG. 19A is a cross-sectional view of one of the worm gear boxes of the drive assembly shown in FIG. 19;

FIG. 20 is an exploded view of the drive assembly shown in FIG. 19;

FIG. 21 is an isometric view of the docking station at the upper end of the frame as shown in FIG. 17;

FIG. 22 is an isometric view of the rotating frame of the machine shown in FIG. 2 without the buoyancy members attached thereto;

FIG. 23 is a front view of the rotating frame shown in FIG. 22;

FIG. 24 is a cross-sectional view of the rotating frame as shown in FIG. 22;

FIG. 25 is a fragmentary enlarged cross-sectional view as shown in FIG. 24;

FIG. 26 is a rear elevational view of the frame body of the rotating member shown in FIG. 22;

FIG. 26A is a side view of the arcuate mounting plate with the bull gear attached thereto which makes up the heart of the rotating frame shown in FIG. 4;

FIG. 27 is an exploded isometric view of the rotating frame shown in FIG. 22;

FIG. 28 is a front elevational view of one of the machines mounted on the rotating frame shown in FIG. 22;

FIG. 29 is a side elevational view of the machine shown in FIG. 28;

FIG. 30 is an exploded view of the machine shown in FIG. 28;

FIG. 31 is a cross-sectional view of the machine shown in FIG. 28;

FIG. 32 is an enlarged side elevational view of the tool retainer in the machine shown in FIG. 28;

FIG. 32A is an exploded isometric view of the tool shown in FIG. 32;

FIG. 33 is a front elevational view of another machine mounted on the rotating frame shown in FIG. 22;

FIG. 34 is a side elevational view of the machine shown in FIG. 33;

FIG. 35 is a cross-sectional view of the machine shown in FIG. 33;

FIG. 36 is a front elevational view of yet another machine mounted on the rotating frame shown in FIG. 22;

FIG. 37 is a side elevational view of the machine shown in FIG. 36; and

FIG. 38 is a side elevational view of the tool retained in the machine shown in FIG. 36;

FIG. 39 is an isometric view of the tool shown in FIG. 37;

FIG. 40 is a top view of a lock down device for the machine shown in FIG. 2;

FIG. 41 is a cross-sectional view of the lock down device shown in FIG. 40;

FIG. 42 is a cross-sectional view of a drive assembly for releasing the lock down device shown in FIGS. 40 and 41; and

FIG. 43 is a diagram showing the us of the device shown in FIG. 2.

### DETAILED DESCRIPTION OF PREFERRED EMBODIMENT

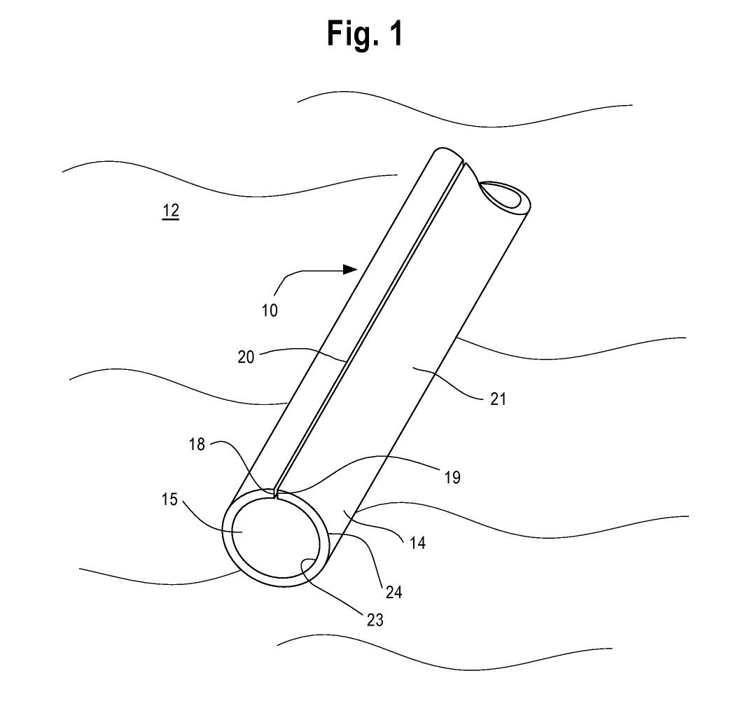

Referring to FIG. 1, a length of underwater pipe 10 that extends along the ocean floor 12 has an annular metal wall 14 having an inner surface 15 and an outer surface 16. The pipe 10 is formed by bending a steel plate having side walls 18, 19 until the walls 18,19 abut each other. Thereafter, the abutting surfaces 18, 19 are welded to each other to form an elongate weld seam 20 that extends longitudinally along an outer surface of the formed pipe 10. The weld seam 20 generally protrudes above the outer surface 18 of the pipe 10 and extends along the entire length thereof. The outer surface 16 of the pipe 10 is also given a fusion bonded epoxy coating 21. Such underwater pipes 10 transport liquids and gas from off shore drill units and the like to shore based facilities. Such pipes generally have inner diameters of twelve inches, twenty inches, and twenty-four inches.

When a portion of the length of pipe 10 becomes damaged as a result of movement of tectonic plates or the dragging of an anchor, the pipe 10 must be cut on each side of the damaged portion and the damaged portion of the pipe removed, leaving an end 22 of the pipe 10 that extends in a first direction, and another end 22 of the length of pipe that extends in the opposite direction. Before a repair section can be positioned between the two ends 22, each of the ends 22 must be prepared so that they may receive a connector that is attached to each of the ends of the repair section.

To prepare an end 22 of the pipe 10, the annular inner edge 23 of the pipe end 22 must be beveled and the annular outer edge 24 of the pipe 10 must also be beveled. Several inches of the weld seam 20 in the immediate proximity of each end 22 also must be removed. To provide continuous grounding of the length of pipe 10, an annular ring of the fusion bonded epoxy coating 21 on the outer surface 16 near the end 22 of the pipe 10 must be removed to allow electrical connection between the connector of a repair part and the metallic wall of the pipe 10. Once the two ends 22 of the remaining pipe 10 are prepared, the replacement pipe having longitudinally slideable connectors can be fitted between the ends and the connectors engaged to thereby repair the pipe.

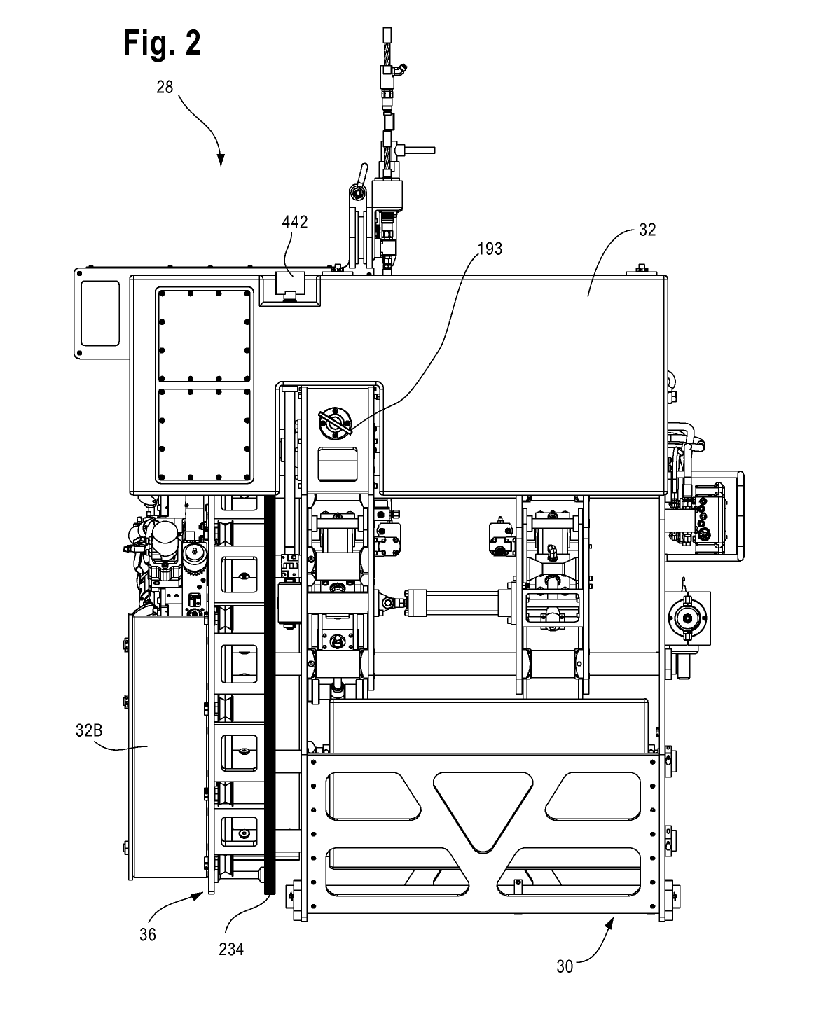

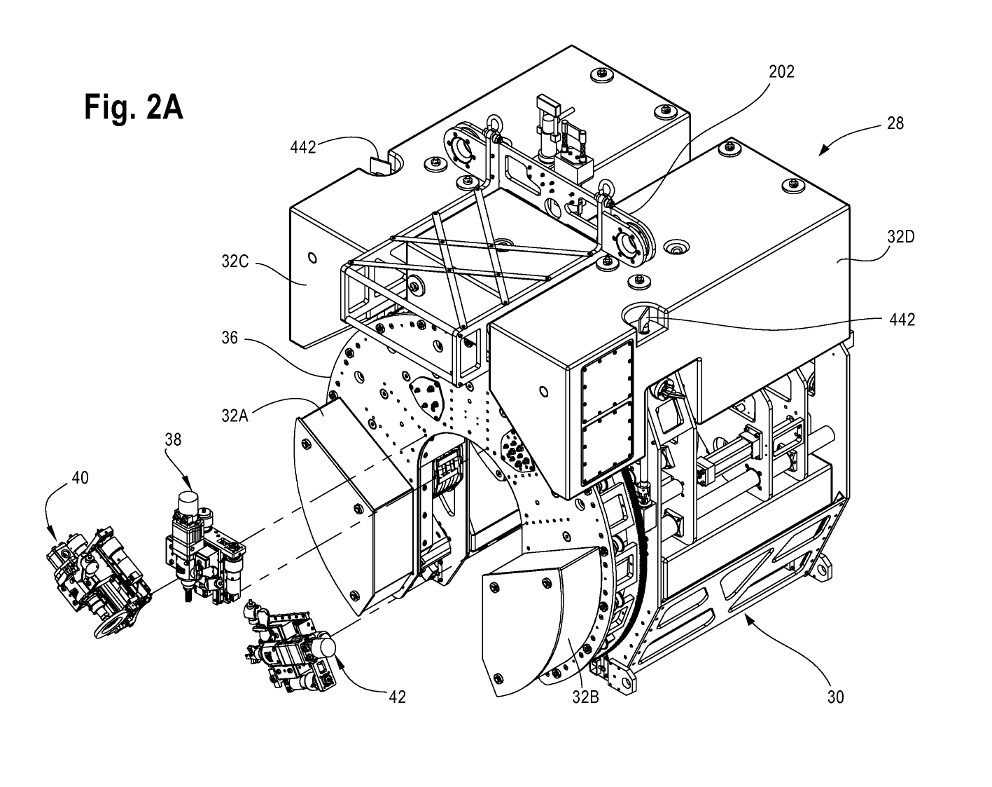

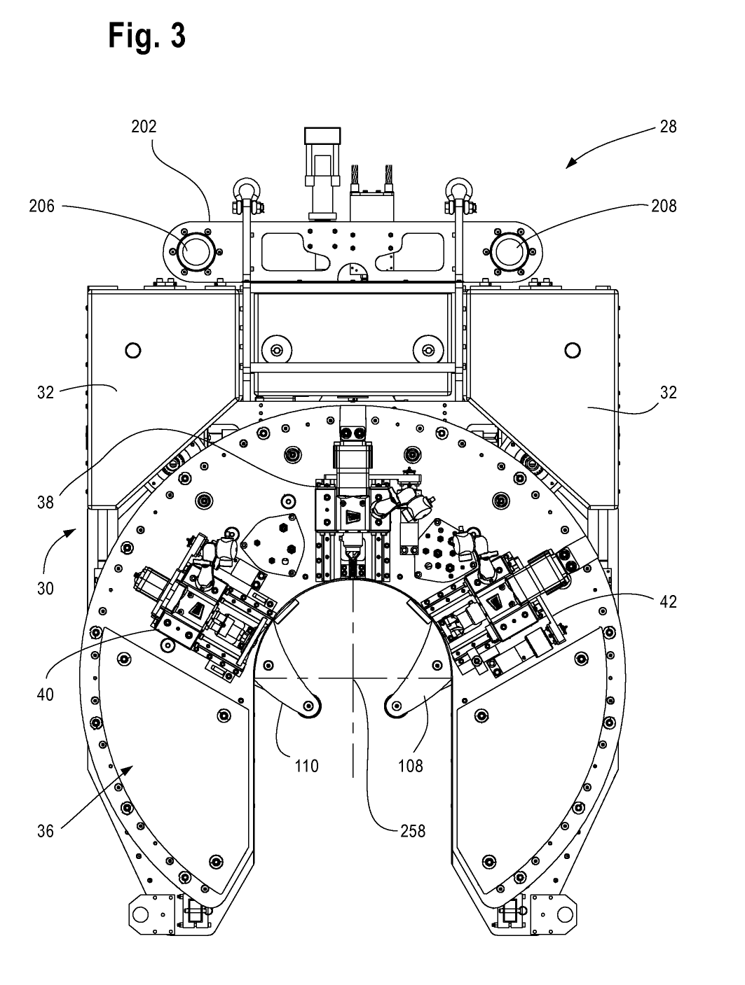

Referring to FIGS. 2 and 3, in order to undertake the steps needed to remove a section of defective pipe and to prepare the ends of the remaining pipe for receipt of a repair section, a support frame, not shown, is provided that supports a section of the pipe 10 above the ocean floor 12. With the pipe 10 retained above the ocean floor 12, a machine 28 in accordance with the present invention is used to cut the pipe 10 at opposite ends of the damaged portion, after which the damaged portion, not shown, can be removed. Once the damaged portion of the pipe is removed, the machine 28 is then used to prepare the two ends 22 of the remaining pipe by beveling the inner edge 23, the outer edge 24, removing a portion of the weld seam 20, and removing an annular portion of the fusion bonded epoxy coating 21.

Referring to FIGS. 2, 3, and 4, the deep water pipe preparation machine 28 includes a platform frame 30, best seen in FIGS. 2 and 3, which includes a number of buoyancy members 32 having a specific gravity significantly less than that of water to offset the weight of the metallic parts and ultimately give the machine 28 a relatively light weight when suspended in water. Each of the buoyancy members 32 are preferably made of a foam or the like having qualities that allow it to withstand the pressures of deep water. The frame 30 also has attached thereto various ballast blocks 34 to help balance the lifting qualities of the buoyancy members 32 against the weight of the parts of the machine 28 to maintain the desired orientation within water with a minimum of exterior forces. Rotatably attached to one end of the machine 28 is a rotating frame assembly 36, and mounted on the rotatable frame assembly 36 are first, second, and third machines 38, 40, 42, each of which is able to perform one or two of the steps needed to prepare the pipe ends 22 to receive a repair section.

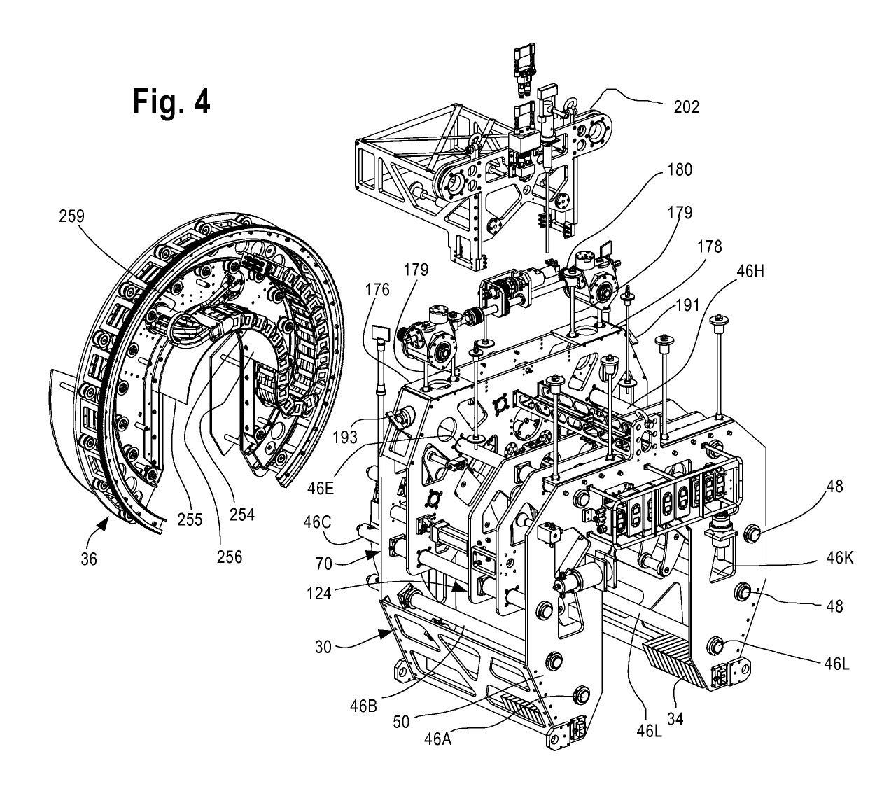

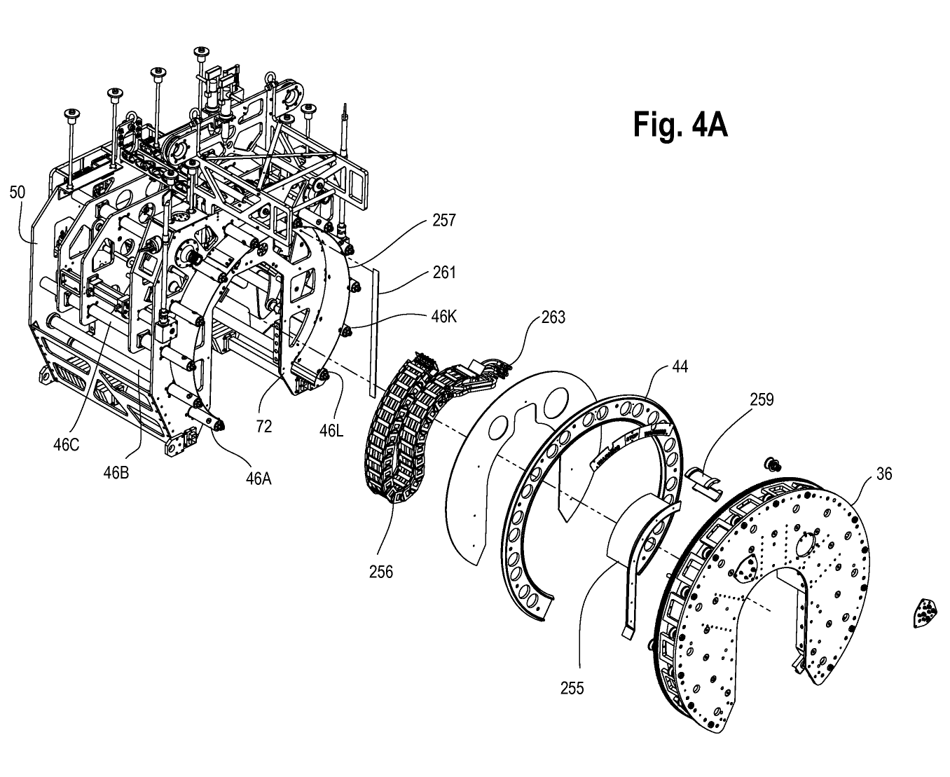

As shown in FIG. 4, the machine 28 is adapted to fit over a portion of the length of pipe 10 with the rotatable frame assembly 36 positioned against an end 22 thereof to undertake the machining operations needed to repair the end 22 to receive a pipe connector of a repair length, not shown. The machine 28, is therefore oriented in the water with the large buoyancy members 32 oriented towards the surface while other portions having ballast blocks 34 thereon oriented towards the ocean floor. Accordingly, the portions of the machine 28 that are oriented closer to the surface of the water are considered as being upward or above the portions oriented closer to the ocean floor. Similarly, when the machine 28 is positioned along a length of pipe 10 with the rotating frame assembly 36 positioned for performing work on the pipe 10, the rotating frame assembly 36 will be considered the front of the machine 28, and the portions of the platform 30 that are at the end opposite the rotating frame assembly 36 are described as the rear end of the machine 28. In describing the various elements of the machine 28, those portions that are towards the surface of the water when the machine is in normal operation will therefore be described as being the upper ends or upper portions, and those directed toward the ocean floor will be described as the lower ends or lower portions. The portions of any members that are towards the rotating frame 36 will be described as the forward portions or ends, and the portions that are away from the rotating frame 36 will be described as the rearward portions or ends.

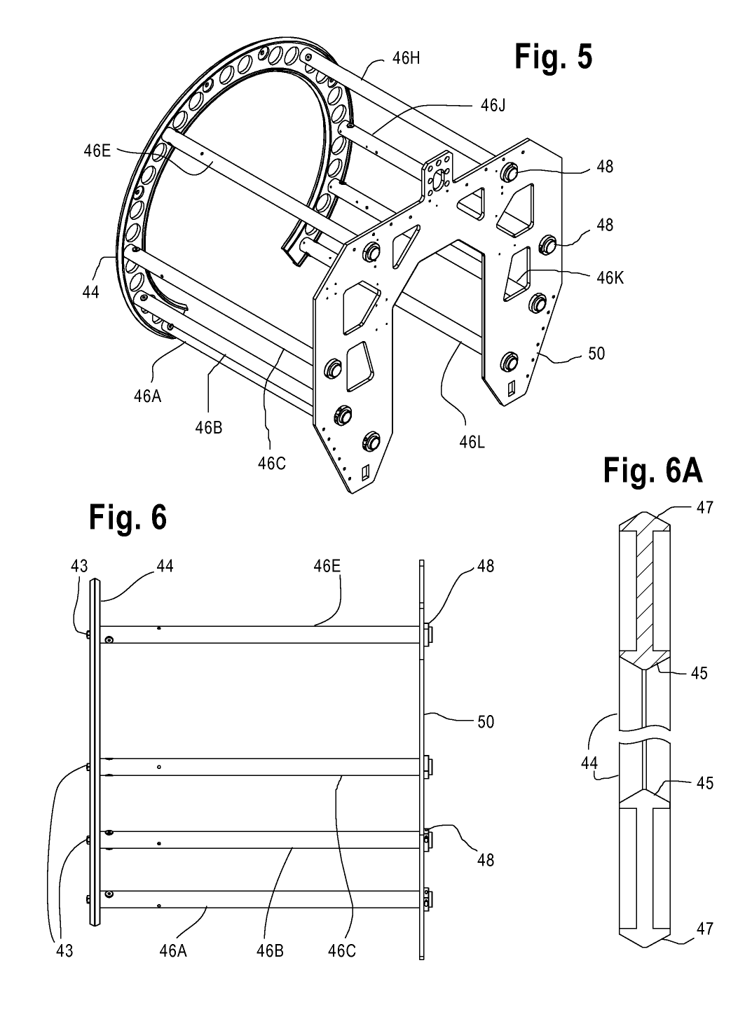

Referring to FIGS. 5, 6, and 6A, at the heart of the frame 30 is a forward split ring 44 that extends through an arc that defines approximately three hundred degrees of a circle. As shown in FIG. 5A, extending around the inner edge of the split ring 44 is a V-shaped inner surface 45 and extending around the outer edge thereof is a similar V-shaped outer surface 47. Eight transverse holes, unnumbered, spaced around the arc of the split ring 44 receive the threaded forward ends of rods 46A, B, C, E, H, J, K, L for retaining the forward end of all the rods 46 to the split ring 44. Nuts 43 on the forward ends of the rods 46A-46L retain the rods to the split ring 44. The rods 46 extend rearwardly from the rear surface of the split ring 44 in parallel spaced apart relationship with the opposite ends thereof attached by clamp collars 48 to a rear plate 50.

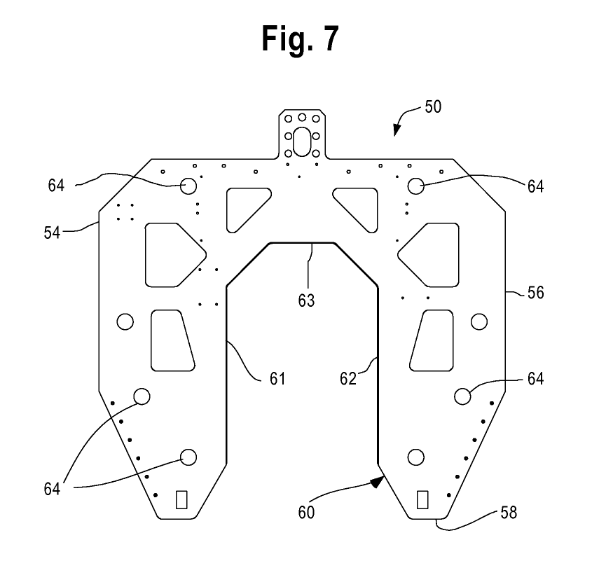

Referring to FIG. 7, the rear plate 50 is oriented vertically and has a generally planar upper surface 52 and parallel side surfaces 54, 56 that taper toward each other at the lower end 58 thereof. Extending upwardly from the lower end 58 is a cutout portion 60 having parallel sides 61, 62 and an arched upper edge 63 joining the upper ends of the side 61, 62 to form the cutout 60. Positioned around the outer edges of the rear plate 50 are eight transverse holes 64 for receiving the rearward ends of the support rods 46 and their associated clamp collars 48.

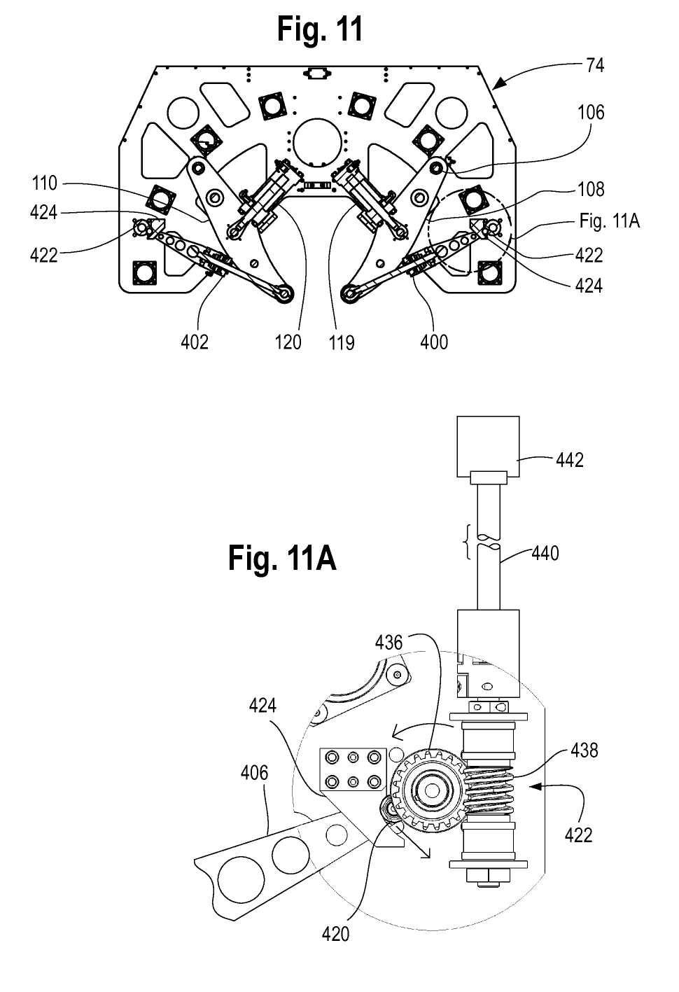

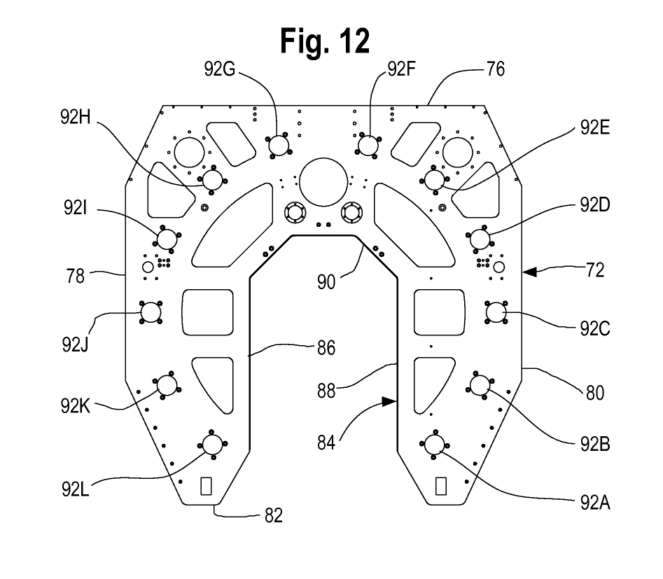

Referring to FIGS. 4 and 8-13, positioned behind the split ring 44 and retained by the rods 46 is a forward clamp assembly 70 which includes a forward plate 72 and spaced a short distance rearward of the forward plate 72, and parallel thereto, a support plate 74. As best shown in FIG. 12, the forward plate 72 has a generally horizontal upper edge 76 and extending downward from each side of the upper edge 76 are side edges 78, 80. The side edges 78, 80 taper toward each other near the lower end and terminate at a bottom edge 82. Extending upwardly into the body of the forward plate 72 is a cutout portion 84 having parallel side edges 86, 88, the upper ends of which connect to an arched upper edge 90. Spaced around the perimeter of the forward plate 72 is a pattern of twelve generally equally spaced apart circular holes 92A to 92L, the centers of which generally define a circle. As shown in FIG. 3, when the forward plate 72 is assembled to the platform 30, the eight support rods 46 extend through holes 92A, 92B, 92C, 92E, 92H, 92J, 92K, and 92L thereof.

As best shown in FIG. 9, the support plate 74 has an upper edge 94 and extending downward from each of the ends of the upper edge 94 are side edges 96, 98 that are a little longer than one-half the length of side edges 78, 80 of the forward plate 72. The bottom edge 100 of support plate 74 has an upward indentation or arch 101 that is complementary to the upper arched upper edge 90 of the cutout portion 84 of the forward plate 72. Also, eight transverse holes 102C, 102D, 102E, 102F, 102G, 102H, 102I, 102J are spaced in an arc near the outer edges of the forward support plate 74. The holes 102C-102J are positioned to align with holes 92C-92J of the forward plate 72. Four of the eight support rods 46 that retain the arcuate split ring 44 to the rear plate 50 extend through holes 102C, 102E, 102H, and 102J of the support plate 74. The plates 72 and 74 are fixed to the support rods 46 by suitable clamps 104, and the plates 72, 74 are retained in fixed spaced relationship to each other by a plurality of spacers 75, some of which 75 are depicted as being rectangular in shape and others of which 77 are generally cylindrical in shape.

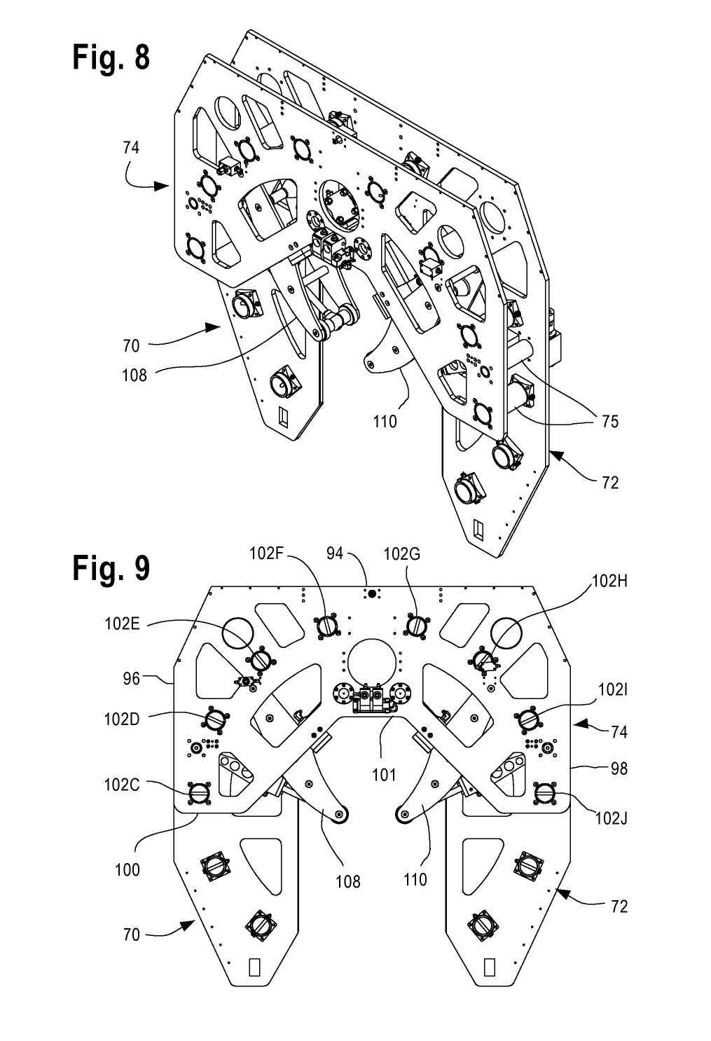

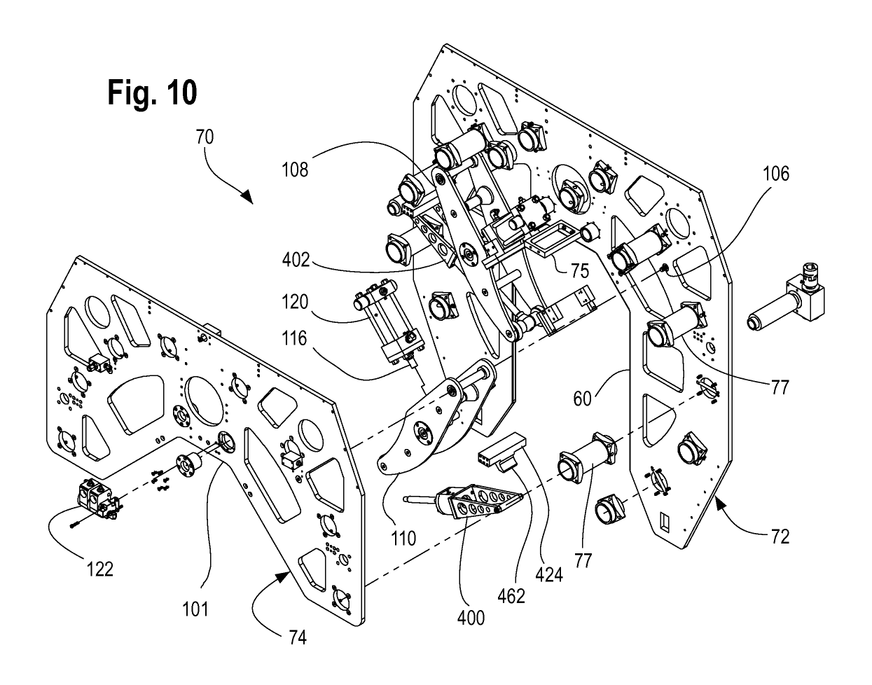

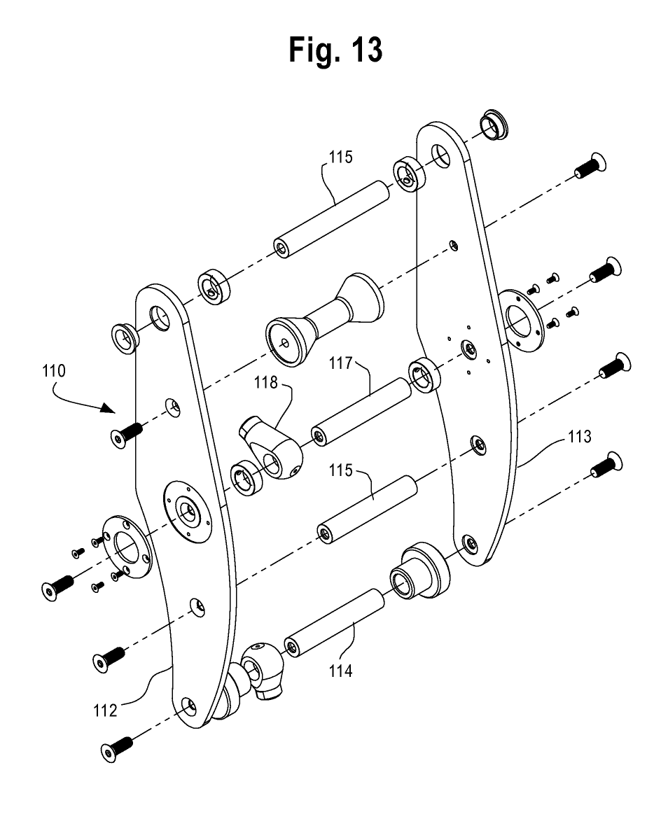

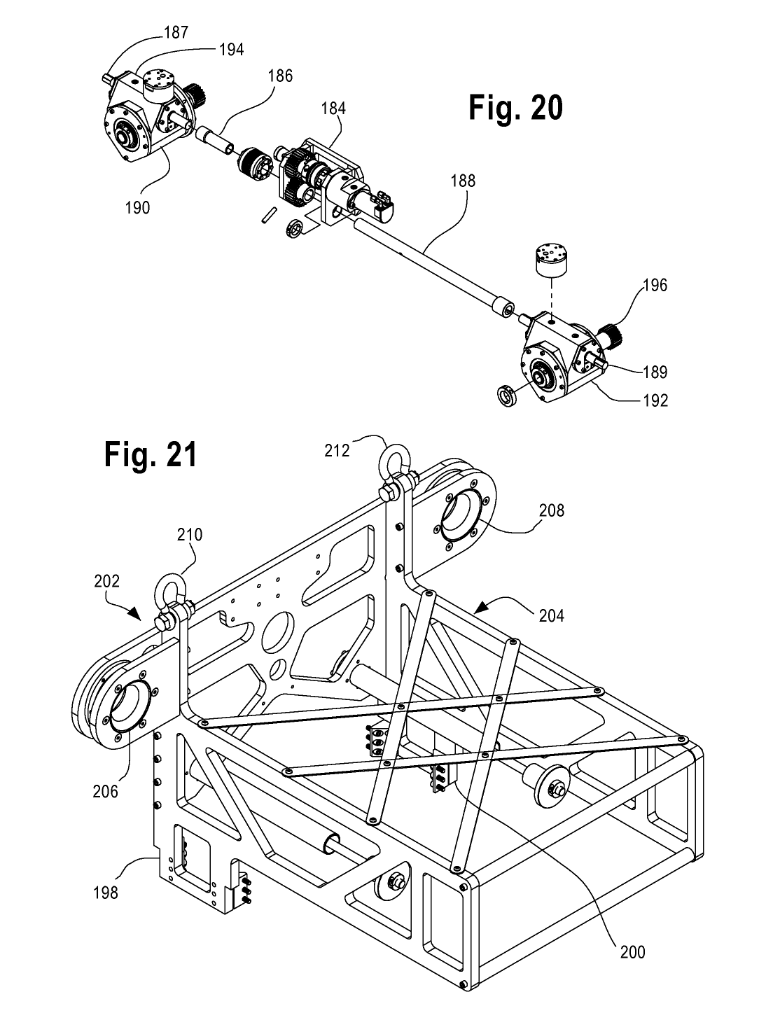

As best seen in FIGS. 8-13, positioned between the forward plates 72 and the support plate 74, and rotatable on opposing pairs of pivot mountings, one of which 106 is visible in FIG. 10, are a pair of forward clamp arm assemblies 108,110. The forward clamp arm assemblies are mirror images of each other and assembly 110 shown in FIG. 13 is representative of both. Each arm assembly 108, 110 has two parallel arm members 112, 113 that are retained in spaced relationship by a plurality of spacers 115. Each of the arm members 112, 113 has an inner end rotatably attached to one of the pivot mountings 106 and an outer end, with the outer ends retained in spaced apart relationship by a crossbar 114. Midway along the length of the arm members 112, 113 is another crossbar 115 having a pivot 118 rotatable thereon, and the pivot 118 is attached to the distal end of a piston rod 116. Each of the forward clamp arm assemblies 108, 110 has an associated reversible hydraulic cylinder 119, 120 for moving the piston rod 116 extending therefrom and thereby moving the outer ends of the clamp arm assemblies 108, 110 towards or away from each other. As best shown in FIG. 20, the operation of the cylinders 119, 120 are coordinated by means of a flow divider 122 to provide synchronized movements of the two clamp arm assemblies 108, 110 for selectively clamping or releasing a grip around a length of pipe 10.

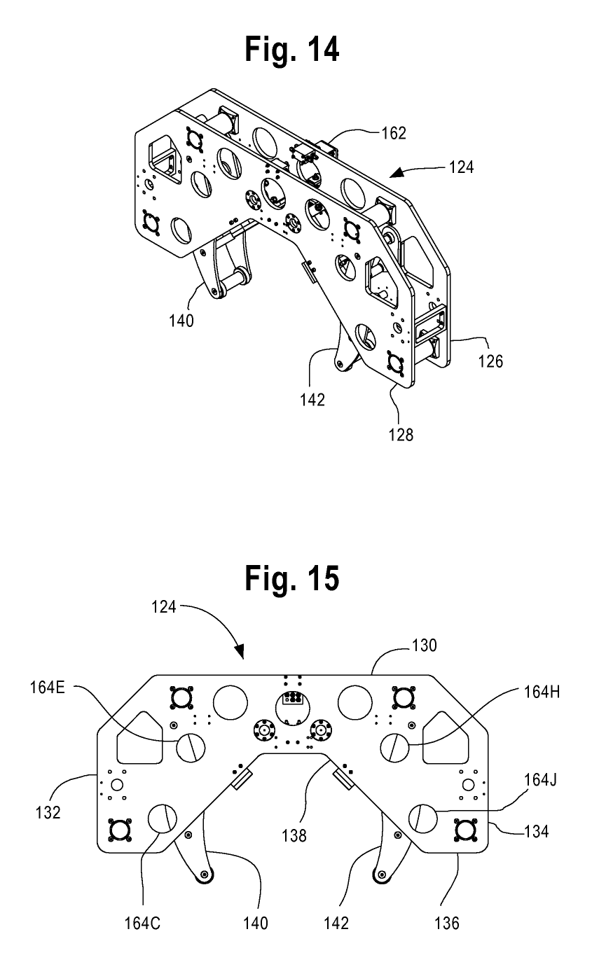

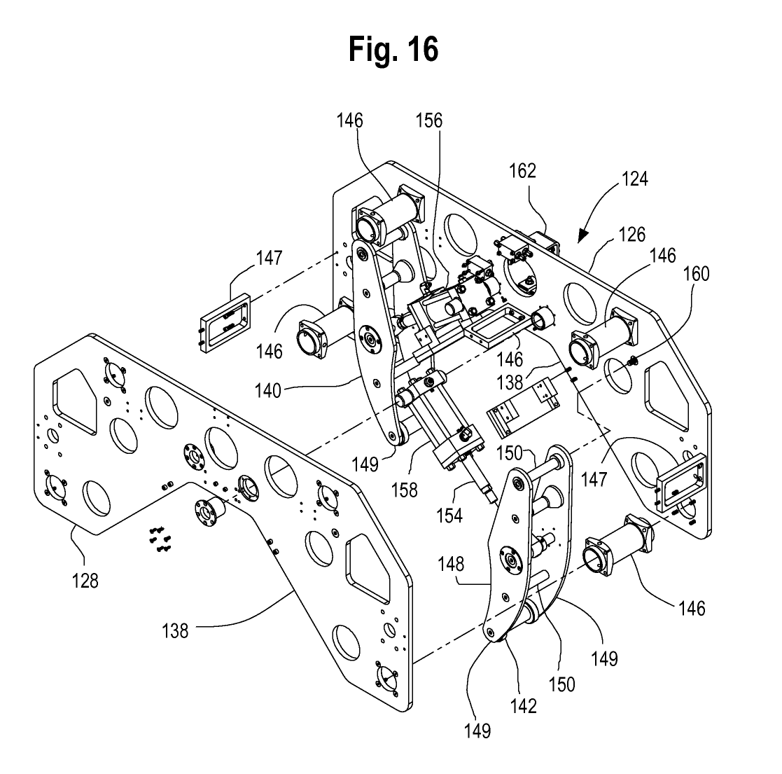

Referring to FIGS. 4, 14, 15, and 16, positioned rearwardly of the forward clamp assembly 70 is a rearward clamp assembly 124 that also has a forward plate 126, and spaced a short distance from the forward plate 126, a parallel oriented rearward plate 128. Each of the forward and rearward plates 126, 128 has a generally horizontal upper edge 130, and extending downward from opposite sides of the upper edge 130 are parallel side edges 132, 134. A plurality of spacers 146 and 147 retain the forward plate 126 and the rearward plate 128 in a fixed spaced relationship to each other. Spacers 146 are depicted as being generally cylindrical in shape while spacers 147 are depicted as being generally rectangular. Connecting the lower ends of the side edges 132, 134 is a lower edge 136, a central portion of which has an upward indentation or arched edge 138. Rotatably mounted between the forward and rearward plates 126, 128 are a pair of rearward clamp arm assemblies 140, 142. Each of the rearward clamp arm assemblies 140, 142 rotates between a pair of pivot mountings attached to the inner surfaces of the forward and rearward plates 126, 128, of which one pivot mounting 144 is visible in FIG. 16.

Each of the rearward clamp arm assemblies 140, 142 has a pair of spaced apart arm members 148, 149 that are retained in spaced relationship by a plurality of spacers 150. The inner ends of the arm members 148, 149 are pivotally received on the pivot mountings 144 and the outer ends of a crossbar 152 to which the distal end of a piston rod 154 is attached. Each of the rearward clamp arm assemblies 140, 142 has an associated reversible hydraulic cylinder 156, 158, each of which is rotatably mounted between opposing pivot mountings on each of the plates 126, 128, one such pivot mounting 160 being visible in FIG. 16. Movement of the piston rod 154 extending from each of the hydraulic cylinders 156, 158 are coordinated by means of a flow divider 162 to ensure that the rearward clamp arm assemblies 140, 142 operate in unison for selectively clamping or releasing a around a length of pipe 10.

The forward and rearward plates 126, 128 each have four transverse holes 164C, 164E, 164H, and 164J, positioned to slideably receive support rods 46C, 46E, 46H, and 46J such that the rearward clamp assembly 124 is longitudinally moveable with respect to the support rods 46.

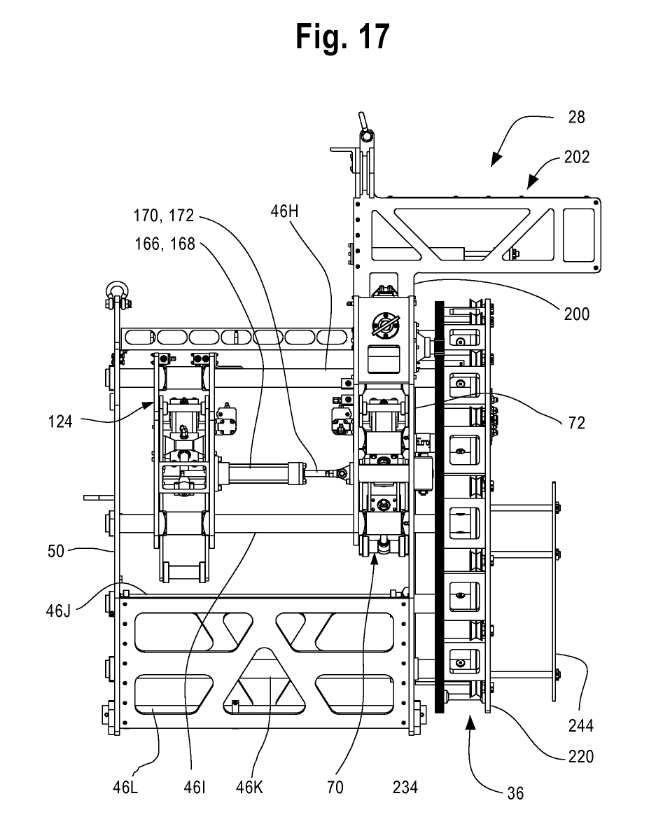

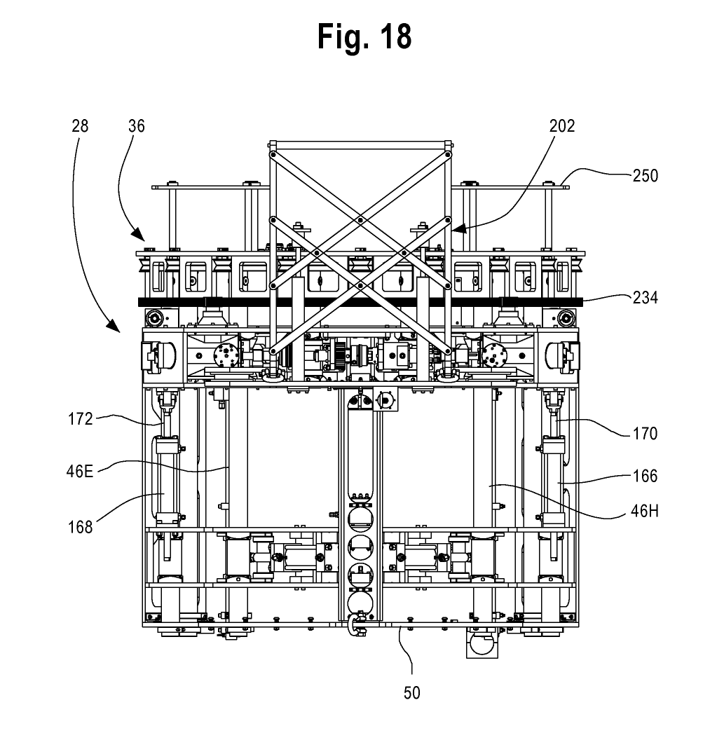

Referring to FIGS. 17 and 18, extending between the forward clamp assembly 70 and the rearward clamp assembly 124 are a pair of spaced apart reversible translation hydraulic cylinders 166, 168. Each of the cylinder bodies 166, 168 is secured to the forward surface of the rearward clamp assembly 124 and the outer ends of the associated piston rod 170, 172 is secured to the rearward surface of the forward clamp assembly 70. The translation hydraulic cylinders 166, 168 will therefore move the rearward clamp assembly 124 toward or away from the forward clamp assembly 70.

Referring to FIGS. 3, 4, 6, 7, 9, 10, and 11, the cutout portion 60 of the rear plate 50, the cutout portion 84 of the forward plate 72 of clamp assembly 70, the upward arched edge 101 of the support plate 74 of clamp 70, and the arched edge 138 of the plates 126, 128 of the rear clamp assembly 124 all align with one another when the parts are assembled to the rods 46. Also, the sides 61, 62 of the cutout portion 60 of plate 50 and the sides 86, 88 of cutout portion 84 of forward plate 72 are spaced the distance sufficiently far apart to slideably receive a pipe 10 having a twenty-fourth inch inner diameter such that the entire frame 30 may be positioned to straddle the pipe 10. Accordingly, when the frame 30 is positioned to surround a length of pipe 10, the cylinders 118, 120 of the forward clamp assemblies 108, 110 can be actuated to cause the outer ends of the arm members 112, 113 to clamp around the circumference of the pipe 10 and the cylinders 156, 158 of the rear clamp assemblies 140, 142 can also be actuated to cause the outer ends of the arm members 148, 149 to also clamp around the pipe 10, to thereby hold the frame 30 securely with respect to the pipe 10.

By actuating the cylinders of the forward clamp assembly 70 to lock around the pipe 10 while the cylinders of the rearward clamp assembly 124 are released, the rearward clamp assembly 124 can be moved to its maximum distance from the forward clamp assembly 70. Thereafter, the cylinders of the rearward clamp assembly 124 can be actuated to lock around the pipe 10 and the cylinders of the forward clamp assembly released. Then, the translational cylinders 166, 168 can be actuated to draw the forward clamp assembly 70 towards the rearward clamp assembly 124. When the forward clamp assembly 70 is as near as possible to the rear clamp assembly 124, the arms of the rearward clamp assembly 124 can be released and the arms of the forward clamp assembly 70 can be locked around the pipe 10 and the translational cylinders 166, 168 extended to again move the rear clamp assembly 124 to its maximum distance from the forward clamp assembly 70. In this fashion, the frames 30 can move in a caterpillar-type walk along the length of the pipe 10 in one direction. By reversing the sequence of locking and releasing the forward and rearward clamp assemblies 70, 124, the frame 30 can walk in the opposite direction along the pipe 10. Accordingly, the machine 28 can be moved longitudinally along the length of the pipe 10 to a desired position where, as will be further described below, the tools thereof can cut the pipe 10 to remove a defective portion thereof, or prepare an end 22 of the pipe 10 for receiving a replacement length. The machine 28 can then be moved to another position along the pipe to perform another function such as remove an unwanted length of weld seam 20 or a portion of the epoxy coating 21.

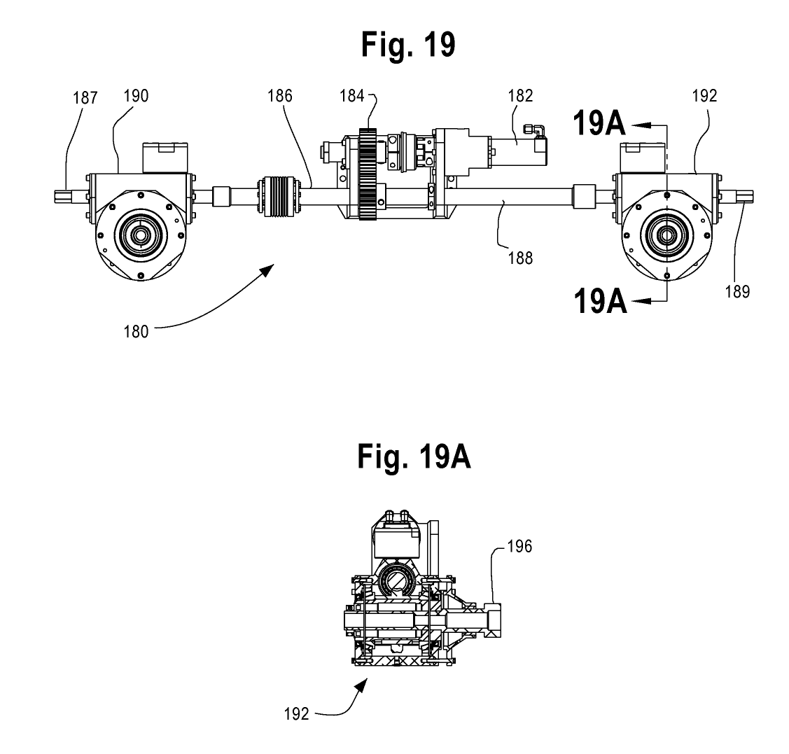

Referring to FIGS. 4, 19, 19A, and 20, mounted on a pair of plates 176, 178 positioned between the upper ends of the forward plate 72 and the forward support plate 74, on a plurality of mounting legs 179 is a drive assembly 180 for rotating the rotating frame assembly 36. The drive assembly 180 includes a hydraulic motor 182 that rotates a gear assembly 184 that drivingly connects to output shafts 186, 188. At the outer ends of each of the output shafts 186, 188, are worm gear drive gear boxes 190, 192, each of which includes a worm gear, not visible, for rotating an output shaft, unnumbered, with a pinion gear 194, 196 at the outer ends thereof. Since each of the pinion gears 194, 196 are drivingly connected through the gear assembly 184, they are synchronized for jointly engaging and driving a bull gear, further described below, on the rotating frame assembly 36 to thereby rotate the frame assembly 36. Attached to the distal ends 187, 189 of output shafts 186, 188 respectively, are paddle handles 191, 193 respectively, visible in FIG. 4. Each of the paddle handles 191, 193 can be rotated by a robotic submarine (shown in FIG. 43) for rotating the frame 36 in the event of a failure of the hydraulic power to the motor 182 as is further described below.

Referring to FIGS. 3, 4, and 21, also mounted on a pair of legs 198, 200 to the front plate 72 and support plate 76 is a docking station 202 consisting of a box shaped frame 204 at the upper end of which are spaced apart docking connectors 206, 208 for receiving connectors for attachment to a robotic vehicle 456 (shown only in FIG. 43) that can maneuver the machine 28 into its desired orientation with respect to a pipe 10. The docking station 202 includes along its upper end a pair of rings 210, 212 for attachment to lines, not shown, that extend to the surface for lowering the machine 28 into the depths and then returning it to the surface.

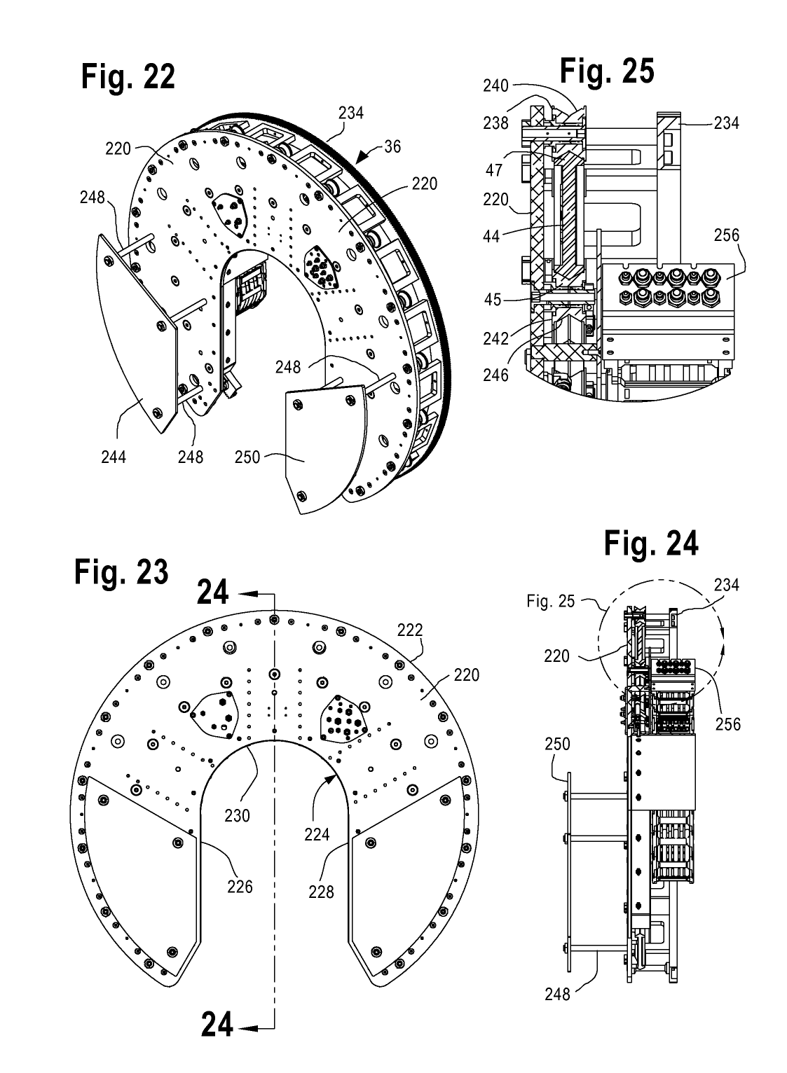

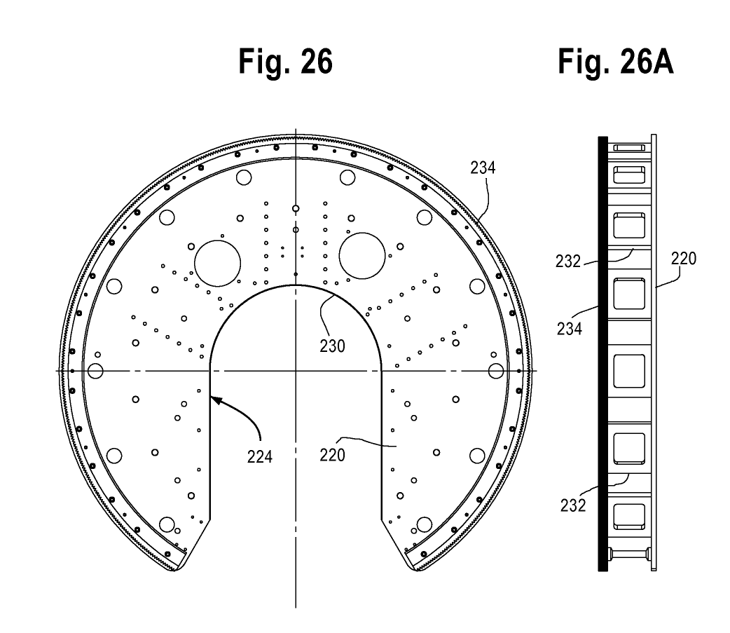

Referring to FIGS. 2, 3, and 22-27, rotatably attached to the split ring 44 of the frame 30 is the rotating frame assembly 36. The heart of the rotary frame assembly 36 is an arcuate mounting plate 220 having an arcuate outer edge 222 that defines a circle having a cutout portion 224. The cutout portion 224 has parallel sides 226, 228 each having one end connected to the outer edge 222 and the opposite end of which connected to opposite sides of an arcuate end portion 230. The arcuate end portion 230 scribes a semi-circle, the center of which is concurrent with the center of the circle defined by the arcuate outer edge 222. Also, the sides 226, 228 are spaced apart a distance that is approximately equal to the distance between the inner sides 61, 62 of the rear plate 50 and between side edges 78, 80 of the forward plate 72 such that the cutout portion 224 of the arcuate mounting plate 220 can fit over a length of pipe 10 until the center line of the pipe 10 is at the center of a circle defined by the arcuate end portion 230 and defined by the outer edge 222.

Secured to the rear surface of the arcuate mounting plate 220 near the outer edge 222 thereof by a plurality of spacers 232 is an arcuate bull gear 234. The arcuate bull gear 234 extends through approximately three hundred degrees of a circle and is aligned with the arcuate edge 222 of the mounting plate 220. Positioned between each pair of spacers 232 is an adjustable rotatably mounted outside bearing 238, the annular outer surface of which bears a groove 240 adapted to receive the V-shaped surface 47 that extends around the outer circumference of the split ring 44.

The arcuate mounting plate 220 also has a second plurality of bearings 242 spaced in an arc defining a circle that is radially inward of bearing 238. Each of the inner bearings 242 has an annular groove 246 sized and positioned to receive the annular V-shaped inner surface 45 of the split ring 44. Accordingly, by assembling the bearings 238, 242 around the inner and outer edges 45, 47 of the split ring 44, the arcuate mounting plate 220 is rotatable on the split ring 44. Also, when the bearings 238, 242 engage the surfaces 45, 47 of the split ring 44, the teeth of the bull gear 234 will be engaged by the pinion gears 194, 196 of the drive assembly 180. It is important that the two pinion gears 194, 196 be spaced apart a distance greater than the distance between the free ends defining the gap in the split bull gear 234. This configuration enables one of the pinions 194, 196 to always be engaged with the teeth of the bull gear 234. Accordingly, the pinion gears 194, 196 can drive the bull gear 234 through more than three hundred sixty degrees of rotation. Preferably, the bull gear 234, and therefore the rotating frame 36, is rotatable through about two hundred ten degrees clockwise and another two hundred ten degrees counterclockwise from the home position shown in FIG. 2. The total rotational range of the frame is therefore four hundred twenty degrees.

As best seen in FIGS. 2,3, 22, and 24, extending from the forward surface of the arcuate mounting plate 220 are a plurality of spacer rods 248 for retaining complementarily shaped retaining plates 244, 250 in spaced relationship from the forward surface of the arcuate mounting plate 220. Retained between each plate 244, 250 and the arcuate mounting plate 220 is a buoyancy member 32A, 32B respectively for assisting in maintaining the proper balance of the machine 28 when it is suspended in water.

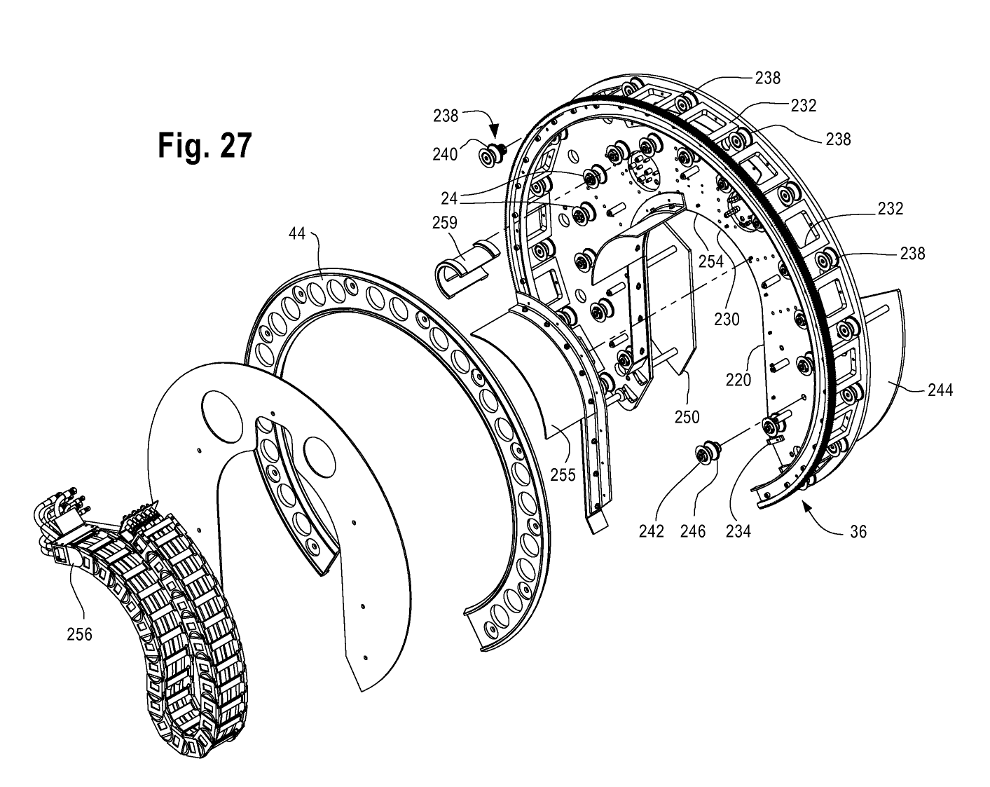

As best shown in FIGS. 4A and 27, positioned against the rearward surface of the arcuate mounting plate 220 and extending around the arcuate end 230 of the cutout 224 are a complementary pair of curved guide panels 254, 255. An arcuate cavity is therefore formed that is bordered on one side by the rearward surface of the arcuate mounting plate 220, and around the cutout 224 by the curved guide panels 254, 255. As shown only in FIG. 4A, the arcuate peripheral edge of the cavity is defined by an arcuate panel 257 that is fitted with the extended support rods 46A-46L that project forwardly from the forward surface of forward plate 72. The arcuate panel 257 also fits within the cylinder defined by the spacers 232 attached to the mounting plate 220. Fitted within the cavity is a flexible cable carrier 256. The cable carrier 256 is of the type having a plurality of identical chain-type links with openings in each of the links for receiving hydraulic tubing and electric cable necessary for the operation of machines 38, 40, 42 mounted on the outer surface of the rotating frame 36. Extending through the length of the cable carrier 256 are all the hydraulic cables and electric cables (not shown in detail) needed to transfer hydraulic power to the motors of the machines 38, 40, 42 and to operate the electronics, such as the camera and light assemblies.

The cable carrier 256 is not designed to bear a load directed perpendicular to its length and will therefore fail unless adequately supported by surfaces that define the cavity including the stationary surface of the forward plate 72 and arcuate panel 257 and the rotating surfaces of the arcuate mounting plate 220 and curved panels 254, 256. We have found, however, that additional guides 259 and 261 are also needed to direct the cable carrier 256 as it unwinds as the frame 36 rotates in one direction and rechanneling the flexible cable carrier 256 back into the cavity as the frame 36 rotates in the opposite direction. Guide 259 extends around the connectors (not depicted) that connect to the ends 263 of the various cables in the cable carrier 256 to the machines 38, 40, 42, camera and lights on the rotating frame 36, and therefore support one end of the cable carrier 256. Guide 261 is a rigid linear bar mounted on the forward surface of the front plate 72. When the rotating frame assembly 36 is oriented with cutout portion 224 aligned with the cutout portion 60 of plate 50, the length of guide 261 will extend parallel to and adjacent to one side 228 of the cutout portion 224 of mounting plate 220. Guide 261 is a stationary guide that extends forward of forward plate 72 to contact the edge of the cable carrier 256, but not far enough to contact portions of the rotating frame 36 as it turns. The guides 259 and 261 permit the cable carrier 256 to be sufficiently long to allow the frame 36 to rotate through an arc from one end of its rotation to the opposite end thereof, which is greater than three hundred and sixty degrees. Without guides 259, 261, a cable carrier 256 having such length will lockup upon itself and fail. Without the guides, such a cable carrier 256 will generally not be useable for members rotating through three hundred and sixty degrees or more.

Referring to FIGS. 3 and 23, the first, second, and third machines 38, 40, 42 are mounted on the forward surface of the arcuate mounting plate 220 of the rotating frame 36 and are oriented to move a rotating tool axially toward and away from the axis of rotation 258 around which the rotating member 36 turns. In the preferred embodiment, the first machine 38 is adapted to cut the pipe 10 transverse to its length and to bevel the outer edge 24 of the pipe end 22. The second machine 40 is adapted to remove a portion of the fusion-bonded epoxy coating 21, and the third machine 42 is adapted to remove a portion of the weld seam 20 of the pipe 10 and to bevel the inner edge 23 of the pipe end 22. The three machines 38, 40, 42 therefore perform a total of five functions needed to prepare the end 22 of a length of pipe 10.

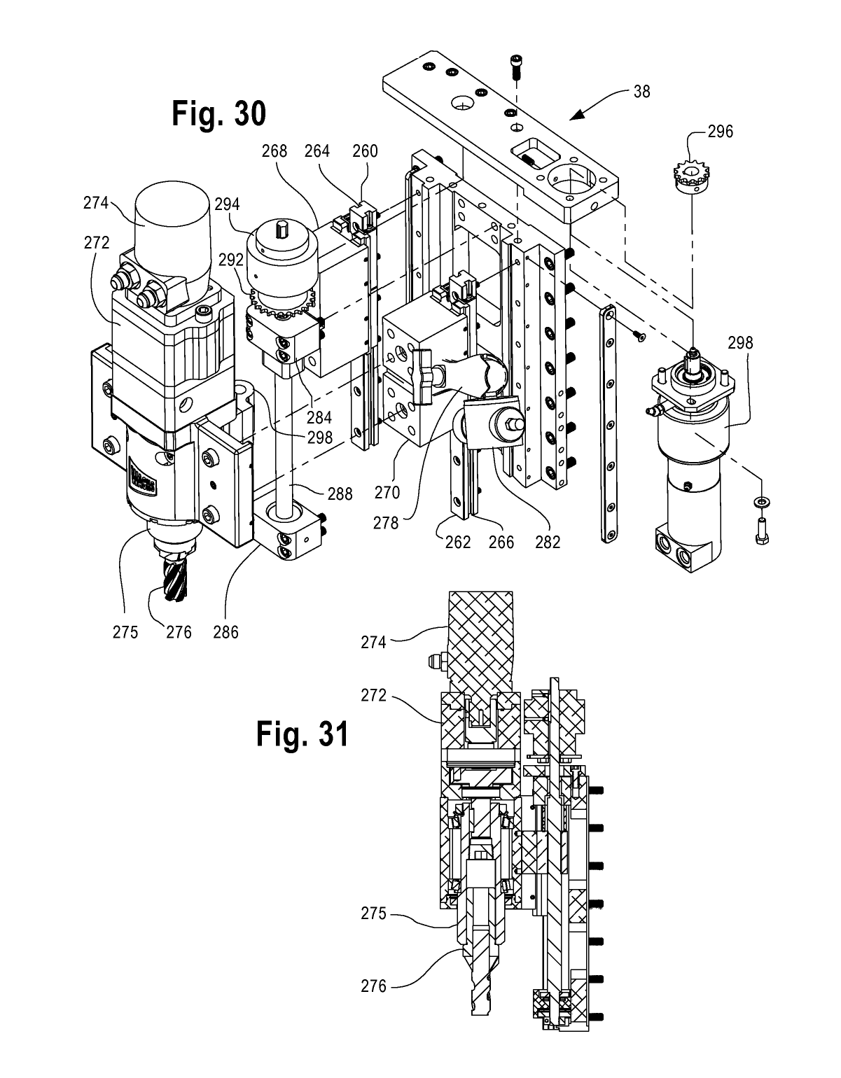

Referring to FIGS. 3, 28, 29, 30, 31 and 43, the first machine 38 is slideably mounted on a pair of spaced apart parallel tracks 260, 262, one on each side of the center line of the radius of the center line of rotation 258 for the rotating frame 36 and are held in place by a plurality of retainers, not identified. On opposite surfaces of each of the tracks 260, 262 are elongate grooves 264, 266 which slideably receive a pair of complementarily shaped inwardly directed projections, not visible, on tract followers 268, 270 to thereby permit the machine 38 to move radially toward and away from the centerline of rotation 258 of the rotating frame 36. Retained to the tract followers 268, 270 is a machine body 272. Since the centerline of the pipe 12 extends through the center 258 of rotation of the rotatable frame 36, the machine body 272 moves on the tracks 260, 262 toward and away from the outer surface of the pipe 12. Extending axially through the length of the machine body 272 is a drive assembly, unnumbered, but shown generally in FIG. 31, which includes a hydraulic motor 274 for rotating an axially aligned tool holder 275, which in turn retains a tool 276. The drive assembly rotates the tool holder 275 and tool 276 around an axis that is oriented generally perpendicular to a centerline of the pipe 10. Mounted to one of the track followers 270 is a bracket 278 that retains at the outer end thereof a video camera and light assembly 282 that is directed toward the working end of the tool 276. The camera is connected by a cable 450 to a monitor 452 on the surface such that a remote operator 458 can visually examine the work being performed by the tool 276.

Mounted by screws or the like, not shown, to the forward surface of the arcuate mounting plate 220 are upper and lower mountings 284, 286 for rotatably receiving a threaded feed screw 288. The feed screw 288 is threadedly received in a follower nut 290 mounted on the rear surface of the machine body 272. At one end of the feed screw 288 is a first sprocket 292, which is drivingly connected to the feed screw 288 through a feed overload friction-type clutch 294. The first sprocket 290 is driven by a chain, not visible, that extends around a second sprocket 296 on the drive shaft of a hydraulic motor 298. The feed overload friction clutch 294 therefore protects the motor 298 against damage in the event an obstruction in the tracks 260, 262 or elsewhere that prevents movement of the machine 38 along the tracks 260, 262.

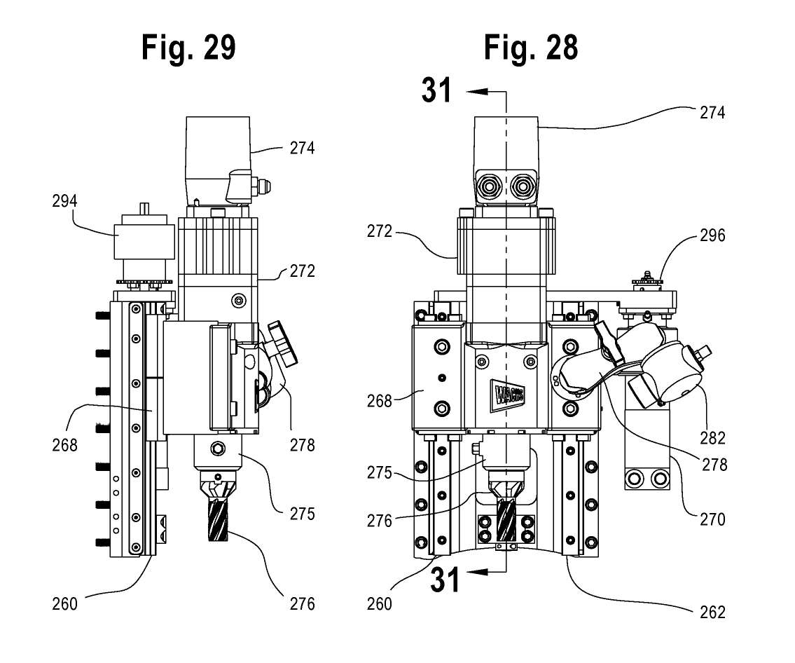

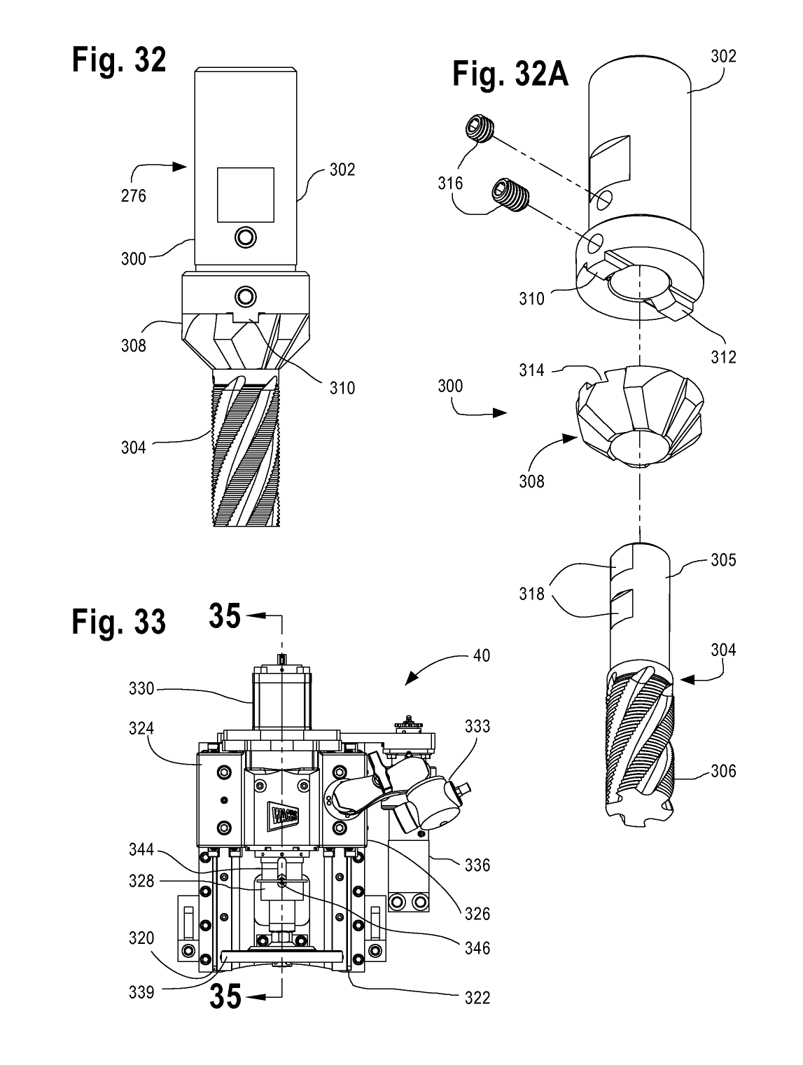

Referring to FIGS. 28, 29, 32, and 32A, the tool 276 rotated by the machine 38 has a tubular tool body 300 with a rearward end 302 adapted to be retained in the tool holder 275. Fitted into the forward end of the tool body 300 is a spiral shaped milling tool 304. Around the circumference of the base of the milling tool 304, immediately behind the milling tool 304 and forward of the tool body 300, is an annular bevel cutter 308. Radial protrusions 310, 312 on the forward end of the tool body 300 are received in a complementary shaped groove 314 on the rearward end of the bevel cutter 308 to lock the bevel cutter 308 for rotation with the tool holder 275. A pair of set screws 316 extend through the tool body 300 and engage flats 318 on the mounting end 305 of the milling tool 304 to ensure that the milling tool 304 rotates with the tool holder 275. It is therefore an important feature of the present invention that the single tool 276 includes the milling portion 304 and the bevel cutter 308 so as to perform two separate operations. The tool holder 275 retains the tool 276 with the longitudinal axis thereof oriented generally perpendicular to the axis of the pipe 10 and perpendicular to the outer surface thereof and the machine 38 is moveable on the tracks 260, 262 to axially move the tool 276 toward and away from the outer surface of the pipe 10. The milling portion 304 can drill through the wall of the pipe 10 after which the machine 38 can be rotated around the circumference of the pipe 10 by the rotating frame 36. The milling portion 304 of the tool will thereby provide a transverse cut in the pipe 10 for removal of a defective portion thereof. Thereafter, the bevel cutter 308 can be applied to the outer edge 24 of the pipe end 22 and the rotating frame 36 turned to bevel the outer edge 24 of the pipe.

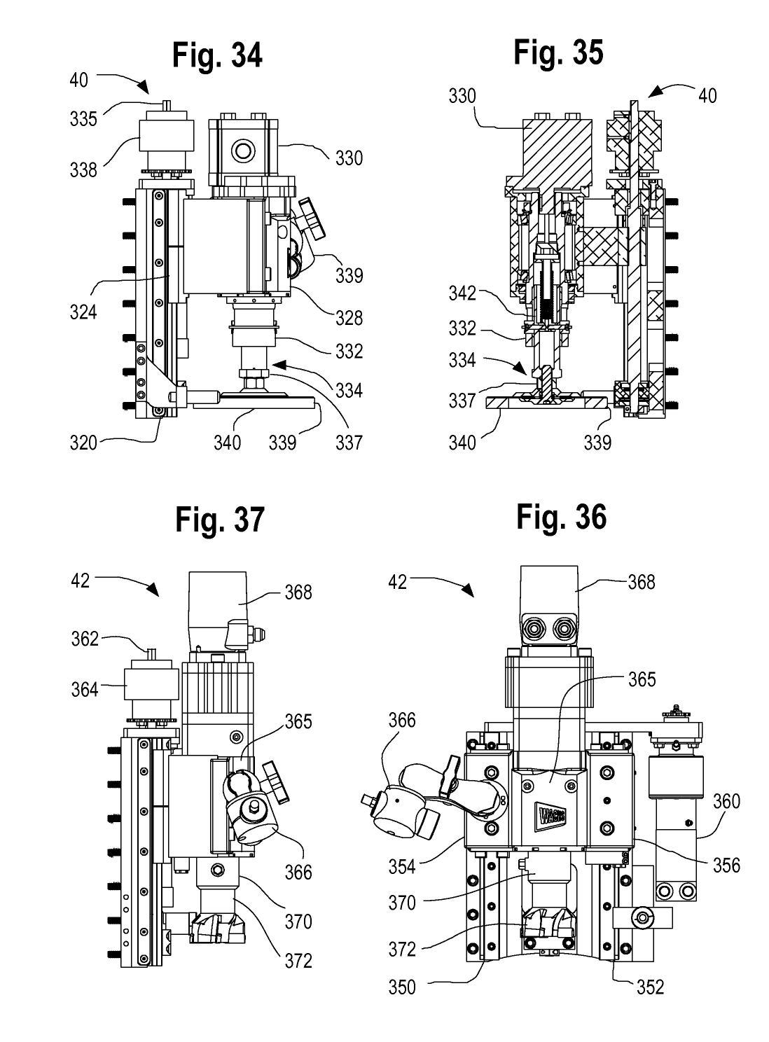

Referring to FIGS. 3, 33, and 34, positioned to one side of the first machine 38 on the forward surface of the rotating frame 36, and mounted for radial movement with respect to a pipe 10 upon which the machine 28 is retained is a second machine 40 for removing an annular ring of the fusion-bonded epoxy 21 from the outer surface of the pipe 10. Like the machine 38, the machine 40 is mounted for radial movement on a pair of tracks 320, 322. A pair of slides 324, 326 slideably engage the tracks 320, 322, and retained on the slides 324, 326 is a machine body 328. A motor 330 rotates a drive assembly, not numbered, that rotates a tool holder 332 about an axis that is generally oriented perpendicular to the axial length of the pipe 10. A tool 334 is received in the tool holder 332. A motor 336 rotates a feed screw 335 by means of a chain drive 338 and a feed overload friction-type clutch 338 to prevent failure of the motor 336. Also attached to one of the slides 326 is a camera and light assembly 333 that are directed toward the tool 334 to permit a remote operator to observe its performance. The tool 334 has a cylindrical mounting portion 337, one end of which is received in the tool holder 332. Extending across the second end of the mounting portion 337 is a rotatable disc 339 having a generally planar outer surface 340 having abrasive qualities suitable for removing fusion-bonded epoxy 21 on the outer surface of a pipe 10.

As best shown in FIGS. 33 and 35, the drive assembly between the motor 330 and the tool holder 332 includes a compression spring 342 for applying a force against the lower surface 340 of the tool 334 against the outer surface of a length of pipe 10. An axial slot 344 in the machine body 328 provides a window through which a camera is directed allow an operator on the surface to visually observe a spring pressure indicator 346 attached to the spring 344 for determining the amount of force that is applied by the tool 34 against the surface of a length of pipe 10.

To remove the fusion bonded epoxy 21 from the surface of a length of pope 10, the cylinders of the forward and rearward clamp assemblies 70, 124 are operated to position the planar surface 340 of the tool 334 opposed to an end portion of the pipe 10. The machine 40 is moved along the tracks 320, 322 until the planar surface 340 contacts the surface of the pipe and the desired pressure is applied as determined by the pressure indicator 346. The motor 336 then axially rotates the tool 339. The rotating frame assembly 36 is turned causing the tool 336 to remove the fusion bonded epoxy 21 from 360 degrees around the surface of the pipe 10. The cylinders of the clamp assemblies 70, 124 are also operated to walk the machine 28 longitudinally along the pipe 10 to remove enough of the fusion bonded epoxy to receive a repair length of pipe, not shown.

Referring to FIGS. 36, 37 and 43, the third machine 42 is mounted on the rotating frame 36 opposite the machine 40 and is slideably retained in a pair of parallel tracks 350, 352 on slides 354, 356. The machine 42 is radially moved along the tracks 350, 352 by a hydraulic motor 360 that rotates a feed screw 362 by means of a sprocket drive, not visible, that drives through a friction-type overload clutch 364. The machine 42 includes a machine body 365 at the upper end of which is a hydraulic motor 368 that rotates a tool holder 370 at the lower end of the tool body 366. The motor 368 rotates the tool holder 370 about an axis that is generally perpendicular to the longitudinal axis of the pipe 10 and is perpendicular to the outer surface of the pipe 10. Mounted on one of the slides 356 is a camera and light assembly 366 that are directed toward a tool 372 such that an operator 458 on the surface can view the tool on a monitor 452 as it works upon the surface of a length of pipe 10. The tool 372 is received in the tool holder 370 and axially rotated by the hydraulic motor 368.

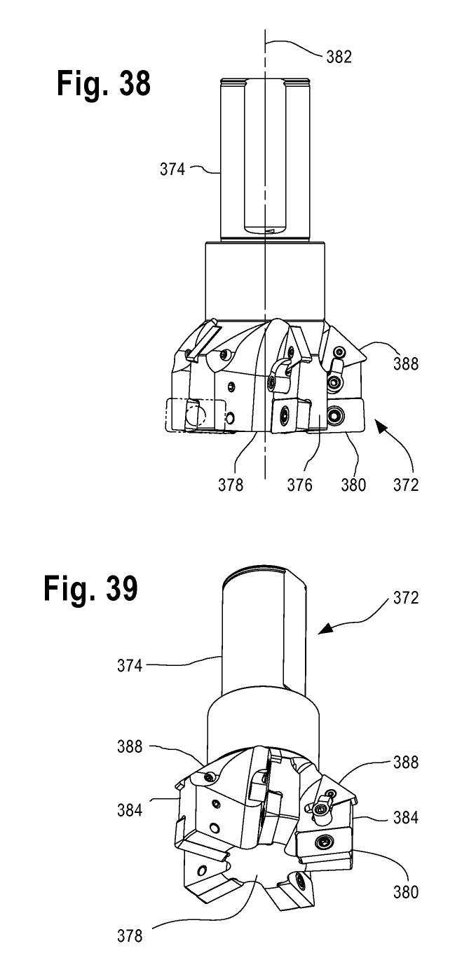

Referring to FIGS. 38 and 39, the tool 372 is symmetrical about its longitudinal axis 382 and has a cylindrical mounting portion 374 and an enlarged working end 376 having a transverse outer end 378. The transverse outer end 378 has a plurality of radially oriented cutting inserts 380 thereof oriented to cut in a plane perpendicular to the axis of rotation 382. The enlarged working end 378 includes a plurality of radially directed ribs 384 having sloping forward surfaces. Cutting inserts 388 on the sloping surfaces are suitable for beveling the inner edge 23 of a length of pipe 10. Accordingly, the tool 372 of the machine 42 is suitable for both removing a portion of the weld seam 20 from the outer surface of a pipe 10 and for beveling the inner edge 23 of an end 22 of a length of pipe 10.

The rotating frame assembly 36 is turned through 360 degrees as the machine 42 is moved along tracks 350, 352 to force the tool 374 against the outer end 22. The cylinders of the clamp assemblies 70, 124 are also operated to longitudinally move the machine 28 along the pipe 10 for the tool 374 to remove an adequate length of weld seam 20.

As can be seen, the machine 28 in accordance with the present invention can provide all five steps needed to cut out a defective portion of a pipe 10 and prepare the two remaining ends 22 of the pipe to receive a replacement length to thereby repair an underwater length of pipe.

The machine 28 is intended for use in deep water, that is one thousand feet or more below the surface of the ocean, and accordingly the device is generally not accessible by a diver operating from the surface. The hydraulic compressor for operating the various cylinders and motors of the device and the control valves are all operable from the surface. As a result of the device being operated far from the surface, the hydraulic lines which control the various functions are subject to failure. Failure can occur as a result of a rupture in a line, interference with a line by a robotic device, or marine life, or by a control vessel that drifts beyond the length of a control cable 450. In the event of failure of the hydraulic lines or failure of the source of the hydraulic fluid, the various motors and cylinders of the device will cease operating. Also, the clamps which are compressed by the hydraulic cylinders around the circumference of the pipe 12 may lose their grip and cause the machine 28 to be released from the pipe 12 and drift with subsurface currents and be lost. To avoid the loss of the machine 12 in the event of a hydraulic failure, the device further includes an emergency lockdown and release feature.

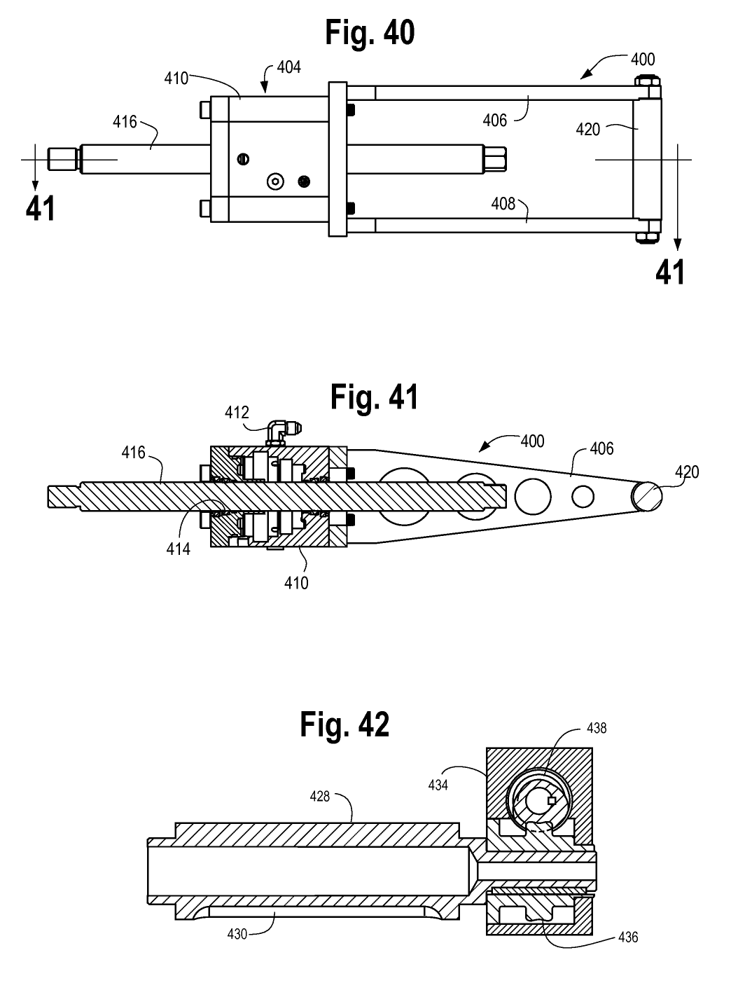

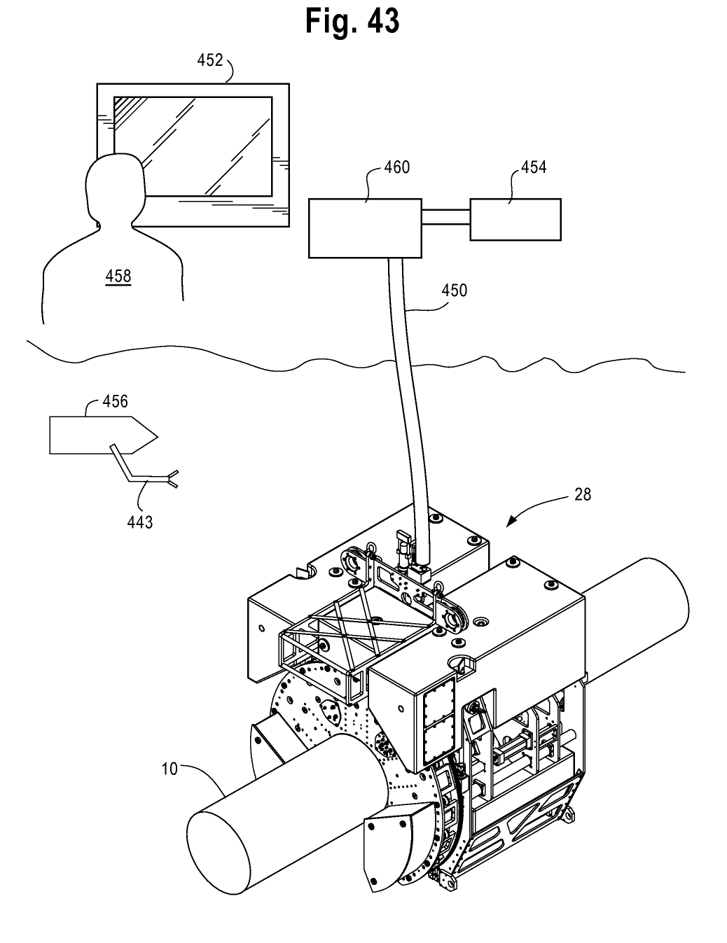

Referring to FIGS. 10, 11, 11A, 40, 41 and 42, the forward clamp assemblies 108, 110 each has associated therewith a lock down device 400, 402, of which device 400 is representative of both. Each lock down device 400, 402 includes an elongate fork 404 having side panels 406, 408 that extend outward of a rodlock device 410 of the type commonly known in the art. The rodlock device 410 has a nipple 412 that attaches to one of the hydraulic lines, not shown, that provides hydraulic pressure to the machine 28. The rodlock device 410 also includes a transverse bore 414 through with a cylindrical rod 416 extends. In the event of loss of hydraulic pressure at the nipple 412, the rodlock device 410 will clamp around the rod 416 and prevent longitudinal movement of the arm 416 within the rodlock device 410. Such rodlock 410 devices are commonly known in the art. The distal end of each rod 416 is pivotally attached to the outer end of one of the pivotal arms 408, 410. The fork arms 406, 408 extend in the direction opposite the distal end of rod 416 and retain a transverse bar 420 therebetween. The transverse bar 420 is rotatably received in a mechanically operated rodlock release 422 that is retained between the forward plate 72 and the support plate 74.

Each rodlock release 422 includes a hook 424 having outer ends that are attachable to the forward plate 72 and support plate 74, and midway along the length between the plates 72, 74 is an arcuate surface 426 adapted to extend around a portion of the transverse bar 402 at the outer end of the rodlock device 400, 402. In normal operation, the lock down device 400, 402 extends between the retaining hook 422 and the outer end of the arms 408, 410. In the event of a failure of hydraulic pressure at the nipple 412, the rodlock device 410 locks the rod 416 against longitudinal movement and retains the ends of the arms 408, 410 locked around the circumference of the pipe 12. After it is determined that it is safe to mechanically release the device 28 from the pipe 12, a mechanical override is needed to release the lock down device 400, 402 so that the arms 408, 410 may be released from the pipe.

The rodlock release 422 therefore includes a rotatable shaft 428 that extends between the forward plate 72 and support plate 74 adjacent the hook 424. The rotatable shaft 428 has a longitudinal groove 430 therein, which in normal usage is aligned opposite the arcuate surface 426 of the hook 424 and retains the transverse bar 420 against the arcuate surface 426 and therefore retains one end of the associated lock down device 400, 402. One end 432 of the rotatable shaft 428 extends through a hole, unnumbered, in the forward plate 72 and extends into a mechanical drive assembly 434 attached to the forward wall of the forward plate 72. Within the drive assembly 434 is a worm gear 436 nonrotatably attached to the distal end 432 of shaft 428. The worm gear 436 engages a worm 438 at the end of an elongate shaft 440 that extends to the upper edge of the machine 28. As depicted in FIG. 43, a paddle handle 442 is at the distal end of each shaft 440 is rotatable by a mechanical arm 443 from a robotically operated submersible 456 controlled from the surface. The paddle handles 442 are also visible in FIGS. 2 and 3.

In the event of a failure of hydraulic fluid, the rodlock devices 400, 402 will lock the arms 108, 110 around the pipe 12 until it is desirable to release the arms and retrieve the device 10. To release the arms 108, 110 from their grip on the pipe 12, the arms 443 of the submersible will grasp the paddle handles 442 and rotate the paddle handles to cause the worm gear 436 to rotate the shaft 428. Rotation of the shaft 128 causes the transverse bar 420 to be urged along the arcuate surface 426 until it is no longer retained between the surface 426 and the rotatable shaft 428. With the transverse bar 420 released, the rodlock devices 400, 420 no longer retain the forward clamp assemblies 108, 110 and the device 28 can be moved from the pipe 12.

Referring to FIG. 43, the machine 28 is connected to the surface of the ocean by a flexible cable 450 that includes electrical lines connecting power to the lights and camera assemblies and transmits a video feed to above-surface monitors 452. The cable 450 also includes hydraulic lines connecting the output of a hydraulic compressor 454 on the surface to the various cylinders of the machine 28. Also on the surface is a control panel 460 that includes valves (not shown) for opening and closing the flow of hydraulic fluid to all the various hydraulic cylinders in the machine 28 and electric controls (also not shown) for operating cameras and lights in the machine 28. The machine 28 is also serviceable by miniature submarines 456 with manipulating arms 458 controlled by the operator 458 that can operate the rod lock devices 400, 402 and position the machine 28 along a length of pipe 12. All of the operations of the machine 28 are therefore controllable by an operator 458 in a boat floating on the surface.

While the present invention has been described with respect to a single embodiment, it will be appreciated that many modifications and variations may be made without departing from the spirit and scope of the invention. It is therefore the intent of the appended claims to cover all such modifications and variations which fall within the spirit and scope of the invention.

What is claimed:

1. A device for preparing a submerged pipe, said device comprising
a platform,
a clamp on said platform,
said clamp selectively clamping and releasing around a circumference of said pipe,
a frame moveably attached to said platform wherein said frame is moveable in an arc of at least three hundred sixty degrees around said pipe and perpendicular to a longitudinal axis thereof,
a first machine on said frame,
said first machine retaining a first tool rotatable about a first longitudinal axis,
said first longitudinal axis extending generally perpendicular to a centerline of said pipe,
said first tool for machining a first surface of said submerged pipe,
a second machine on said frame,
said second machine retaining a second tool with said second tool rotatable about a second longitudinal axis, and
said second tool for machining a second surface of said submerged pipe.

2. The device of claim 1 wherein one of said machines retains a rotatable tool that includes both a cylindrical end mill, and a frustoconical bevel cutter.

3. The device of claim 1 wherein one of said machines retains a tool having teeth for removing a weld seam and having a frustoconical surface for beveling an end of a length of pipe.

4. The device of claim 1 wherein one of said machines is radially moveable toward and away from a surface of said pipe.

5. The device of claim 1 and further comprising a camera and light assembly directed toward one of said tools wherein an operator on the surface can view an operation of said one of said tools.

6. The device of claim 1 wherein said frame has three machines thereon and each of said three machines performs a different function for preparing an end of said pipe.

7. The device of claim 6 wherein one of said machines retains a tool having two cutting portions wherein said tool can perform two preparations on said pipe.

8. The device of claim 6 wherein said three machines can perform five different preparation steps on said pipe.

9. The device of claim 6 wherein all three of said machines are independently radially moveable toward and away from a surface of said pipe.

10. The device of claim 6 and further comprising
A mechanical lock for locking said clamp against movement in the event of loss of hydraulic pressure from a source.

11. The device of claim 10 and further comprising
a plurality of cables connecting said platform to said moveable frame,
a flexible cable carrier enclosing said plurality of cables,
said cable carrier rolling into and out of a cavity as said frame rotates,
a first guide on said frame,
said first guide contacting said cable carrier as said frame rotates,
a second guide on said platform,
said second guide contacting said cable carrier as said frame rotates wherein said first and second guides direct said cable carrier into and out of said cavity as said frame rotates, and
said first guide will pass said second guide as said frame rotates and said first guide will not interfere with said second guide.

12. The device of claim 10 wherein said device includes
a device to cut said pipe perpendicular to its lengths,
a device to bevel an inner circumference of one end of said pipe,
a device to bevel an outer circumference of an end of said pipe,
a device to remove an epoxy coating from a portion of a surface of said pipe, and
a device to remove a portion of a weld seam from said pipe.

13. The device of claim 12 and further comprising
means for longitudinally moving said device along a length of said pipe wherein said device can be positioned to make a cut, and repositioned for removing material from said surface of said pipe.

14. A device for preparing a submerged pipe of the type having a metal wall, a coating bonded to an outer surface, and a longitudinal weld seam, said device comprising
a platform,
a clamp on said platform,
said clamp selectively clamping and releasing around a circumference of said pipe,
said clamp having a moveable jaw for adjustably clamping and releasing around a circumference of said pipe,
said clamp hydraulically operated from a source of hydraulic pressure located remote from said device,
a mechanical lock for locking said jaw of said clamp against movement in the event of loss of hydraulic pressure from said source,
a mechanical lock release for releasing said lock,
a frame moveably attached to said platform wherein said frame is moveable in an arc of at least three hundred sixty degrees around said pipe, and
a plurality of machines on said frame wherein each of said machines performs a different preparation step to a surface of said pipe.

15. The device of claim 14 wherein said lock release is operable by a submersible vehicle separate from said device.

16. The device of claim 14 and further comprising
a plurality of cables connecting said platform to said moveable frame,
a flexible cable carrier enclosing said plurality of cables,
said cable carrier rolling into and out of a cavity as said frame rotates,
a first guide on said frame,
said first guide contacting said cable carrier as said frame rotates,
a second guide on said platform,
said second guide contacting said cable carrier as said frame rotates wherein said first and second guides direct said cable carrier into and out of said cavity as said frame rotates.

17. The device of claim 14 wherein said machine comprises
a device to cut said pipe perpendicular to its lengths,
a device to bevel an inner circumference of one end of said pipe,
a device to bevel an outer circumference of an end of said pipe,
a device to remove an epoxy casting from a portion of a surface of said pipe, and
a device to remove a portion of a weld seam from said pipe.

18. The device of claim 14 wherein each of said plurality of machines is rotatable about an axis perpendicular to an axis of said pipe.

19. The device of claim 16 and further comprising means for moving said device along a length of said pipe wherein said device can be moved to a first position to make a cut and moved to a second position to remove material from an outer surface of said pipe.

20. The device of claim 14 and further comprising a mechanical device operable from an independent submersible for rotating said frame in the event of loss of hydraulic power.
